(19) United States
(12) Patent Application Publication
(10) Pub. No.: US 2017/0177600 A1
(43) Pub. Date: Jun. 22, 2017

(54) METHOD, SYSTEM, AND DEVICE FOR PROCESSING DATA IN CONNECTION WITH AN APPLICATION

(71) Applicant: Alibaba Group Holding Limited, George Town (KY)

(72) Inventors: Yingchun Zhang, Beijing (CN); Huan Zeng, Beijing (CN); Kezheng Liao, Beijing (CN)

(21) Appl. No.: 15/371,024

(22) Filed: Dec. 6, 2016

(30) Foreign Application Priority Data
Dec. 9, 2015 (CN) 201510907416.6

(51) Int. Cl. G06F 17/30; G06F 9/44; G06F 17/21; G06F 3/0488; G06F 3/16

(52) U.S. Cl. CPC G06F 17/3097; G06F 3/04883; G06F 3/167; G06F 17/218; G06F 9/4443; G06F 17/30991

(57) ABSTRACT

Embodiments of the present application relate to a method, device, and system for processing data. The method includes receiving an input to an application interface non-control zone of a current application, determining whether the input satisfies a preset query trigger condition, in the event that the input is determined to satisfy the preset query trigger condition, displaying a system control, wherein the system control obtains one or more interface elements related to the current application and displays the one or more interface elements, receiving a triggering of at least one of the one or more interface elements, and in response to the triggering of the at least one interface element, displaying a query response interface, wherein the query response interface is obtained according to a query condition associated with the triggered at least one interface element.

### CROSS REFERENCE TO OTHER APPLICATIONS

This application claims priority to People's Republic of China Patent Application 201510907416.6 entitled A METHOD, A DEVICE AND A SMART TERMINAL FOR PROCESSING DATA filed Dec. 9, 2015 which is incorporated herein by reference for all purposes.

### FIELD OF THE INVENTION

The present application relates to a field of technology for operating a terminal. In particular, the present application relates to a method, device, and terminal for performing a predefined function or recommending a function to execute on a terminal based on a context of an application being executed on the terminal and one or more inputs thereto.

### BACKGROUND OF THE INVENTION

As technology for operating a terminal develops, an increasing number of users are adopting terminals such as smart terminals. Users can install various types of applications (also referred to as apps) on the terminals. Different apps can have the same or different functions.

For example, a player app can play audio/video; a shopping app can be used to facilitate online purchasing; a notebook app can be used to record itineraries, plans, etc. While using a terminal, a user may search for an app to perform the required operation. The user may also search within an app for data provided by the app in which the search is being performed (e.g., a shopping app can be queried for certain types of products). However, many apps may be installed on a terminal, and the apps may provide the user with an overwhelming amount of information. For example, a contacts list may store hundreds of telephone numbers. An abundance of apps and information makes performing queries difficult. For example, the large number of apps and information stored on conventional terminals creates certain inefficiencies for users (e.g., for finding a specific app, or for finding specific information).

Therefore, a method, a device, and a smart terminal for processing data on a terminal is needed in order to address the problems with executing queries on terminals.

### BRIEF DESCRIPTION OF THE DRAWINGS

Various embodiments of the invention are disclosed in the following detailed description and the accompanying drawings.

FIG. 1 is a flowchart of a method for data processing according to various embodiments of the present application.

FIG. 2 is a diagram of an interface according to various embodiments of the present application.

FIG. 3 is a flowchart of a method for data processing according to various embodiments of the present application.

FIG. 4 is a flowchart of a method for data processing based on a swipe input according to various embodiments of the present application.

FIG. 5 is a diagram of an interface according to various embodiments of the present application.

FIG. 6 is a flowchart of a method for data processing based on an input according to various embodiments of the present application.

FIG. 7 is a diagram of an interface diagram according to various embodiments of the present application.

FIG. 8 is a flowchart of a method for data processing based on a swipe input according to various embodiments of the present application.

FIG. 9 is a structural block diagram of a data processing device according to various embodiments of the present application.

FIG. 10 is a structural block diagram of a data processing device according to various embodiments of the present application.

FIG. 11 is a structural block diagram of a mobile terminal according to various embodiments of the present application.

FIG. 12 is a functional diagram of a computer system for processing data according to various embodiments of the present disclosure.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

To make the above-described objectives, features, and advantages of the present application plainer and easier to understand, the present application is explained in further detail below in light of the drawings and specific embodiments.

Various embodiments include a method, a device, and a terminal for processing data in connection with executing queries on terminals such as smart terminals. Various inputs to a terminal (e.g., an app running on a terminal) include an app receiving an input in an app interface non-control zone. Various inputs include displaying a system control in response to determining that the input satisfies a preset query trigger condition. The displaying of the system control can include obtaining interface elements related to the current app, and in the event that the interface element is triggered, displaying the query response interface obtained according to the query condition corresponding to the triggered interface element. Various embodiments can actively predict one or more characteristics associated with a user query based on current app input. Various embodiments thus actively display a system control and by using an interface element therein provide a query condition to assist the user in querying. Accordingly, some embodiments improve user efficiency of the app and/or the terminal.

As used herein, a terminal generally refers to a device used (e.g., by a user) within a network system and used to communicate with one or more servers. According to various embodiments of the present disclosure, a terminal includes components that support communication functionality. For example, a terminal can be a smart phone, a tablet device, a mobile phone, a video phone, an e-book reader, a desktop computer, a laptop computer, a netbook computer, a personal computer, a Personal Digital Assistant (PDA), a Portable Multimedia Player (PMP), an mp3 player, a mobile medical device, a camera, a wearable device (e.g., a Head-Mounted Device (HMD), electronic clothes, electronic braces, an electronic necklace, an electronic accessory, an electronic tattoo, or a smart watch), a smart home appliance, vehicle-mounted mobile stations, or the like. A terminal can run various operating systems.

A terminal can have various input modules. For example, a terminal can have a touchscreen, one or more sensors, a microphone via which sound input (e.g., speech of a user) can be input, a camera, a mouse or other external input device connected thereto, etc.

As used herein, a smart terminal refers to terminal devices that have multimedia functions. Smart terminals can correspond to devices that support audio, video, data, and/or other functions. In some embodiments, a smart terminal has a touchscreen. Smart terminals can include mobile terminals such as smartphones, table computers, and smart wearable devices. Smart terminals can be a smart television, a personal computer, or another device with a touchscreen.

While using a smart terminal, a user may select an app from a main interface, such as a desktop, and may use the app to perform appropriate operations. The app can be selected based on a selection of an icon associated with the app. The selection can be input via a touchscreen of the terminal. Various embodiments include a system-level assistant control to make use of a terminal easier. The system-level assistant control can correspond to a system control configured into the smart terminal. According to various embodiments, the system control is displayed in various application scenarios of a smart terminal. For example, the system control can be displayed on a system desktop or displayed in the process of using an app. The system control can be (or appear to be) a function in the app being used, or as an overlay while the app is being used and information thereof is being displayed. According to various embodiments, when a user is in the process of using the app, the user can use the default way to trigger system controls, and use shortcut functions provided by the system controls. In some embodiments, the default mode of the trigger corresponds to the app interface of the non-control area operation. For example, if the user manipulates the control area of the app interface, the application responds to the application function corresponding to the control. As an example, in the case of a Short Messaging Service (SMS) app, if the “send button” of the SMS interface is triggered, the SMS app sends the short message.

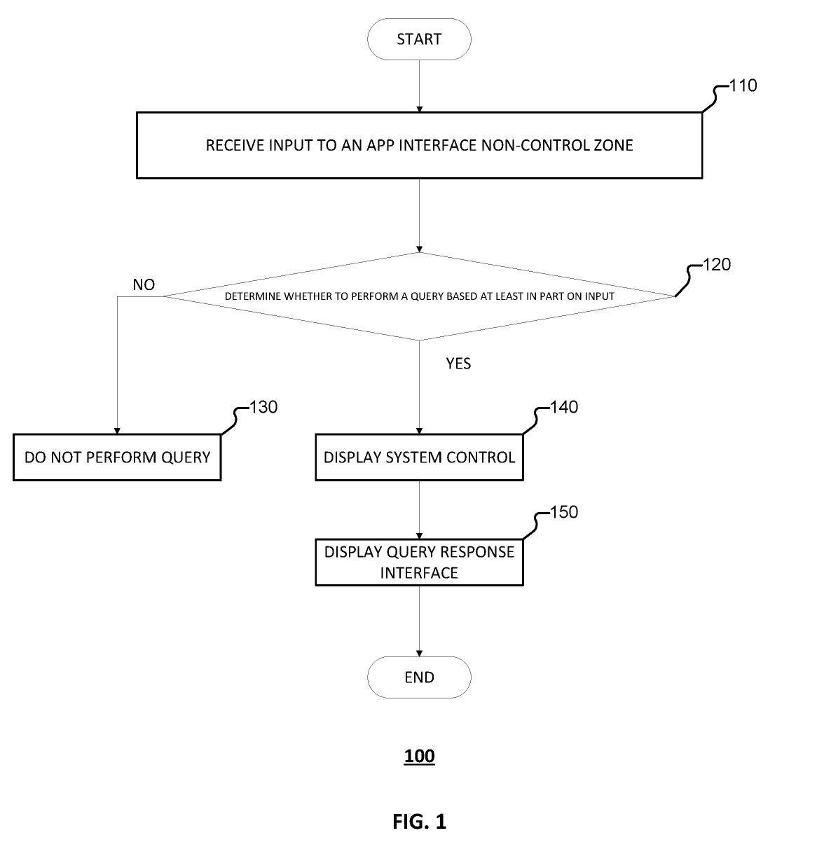

FIG. 1 is a flowchart of a method for data processing according to various embodiments of the present application.

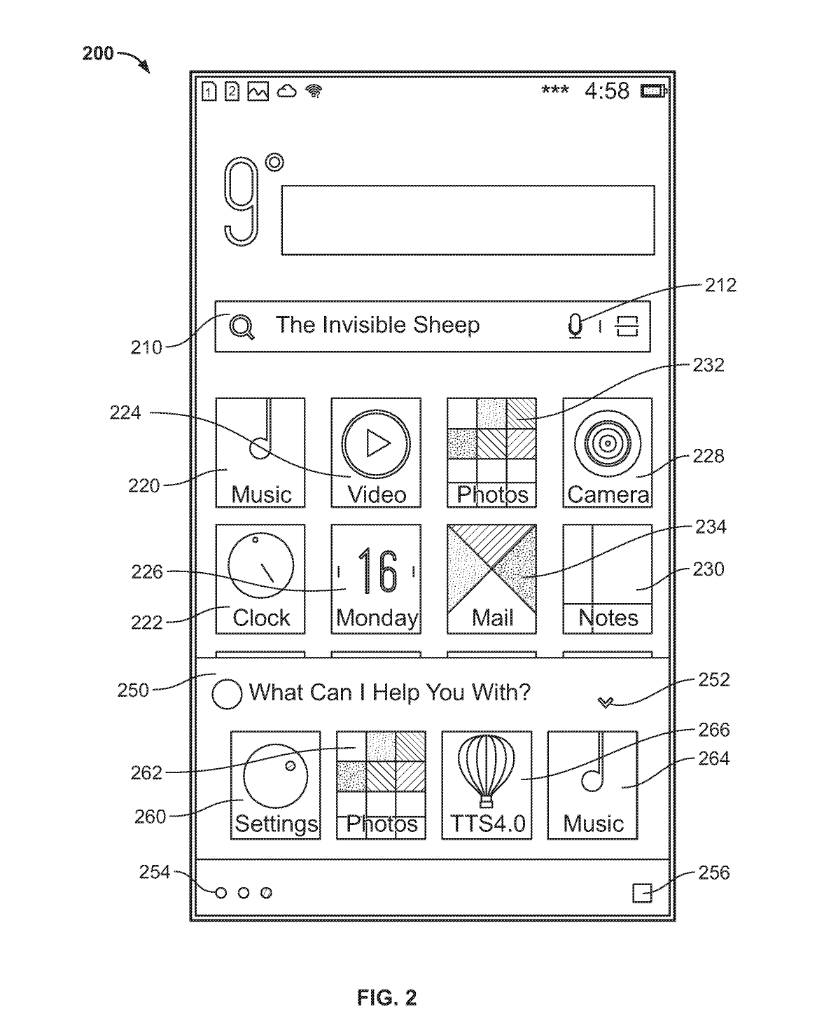

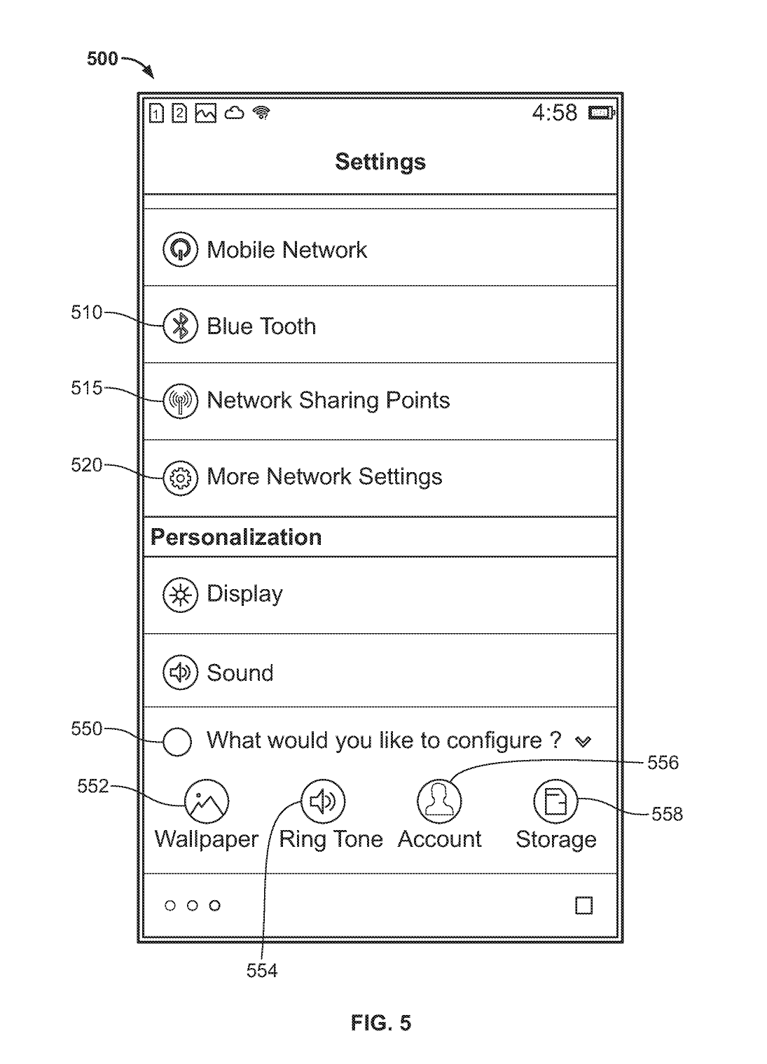

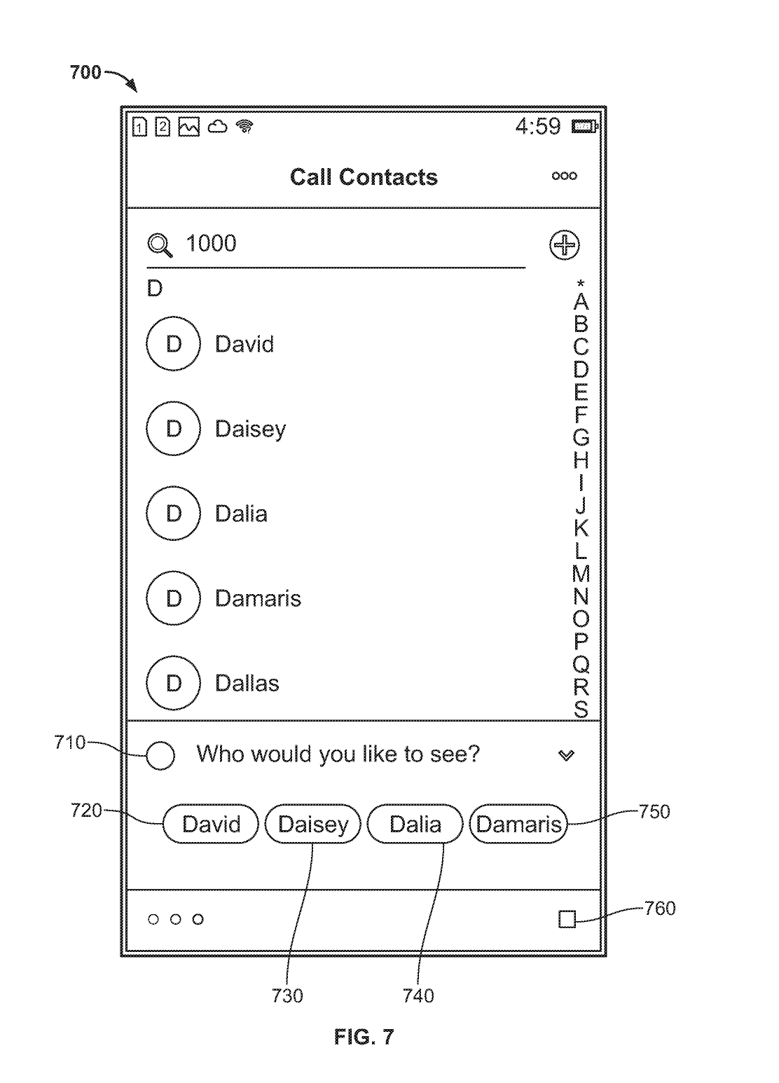

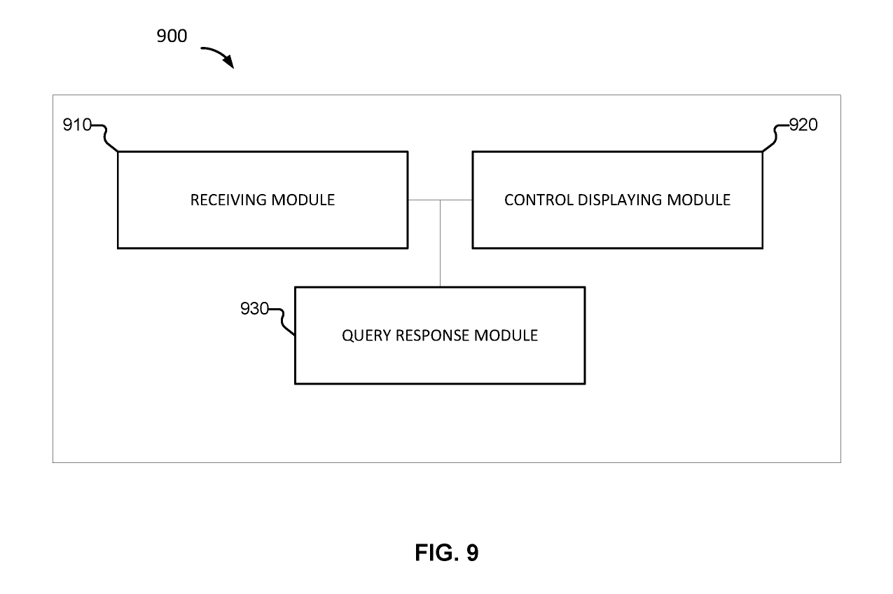

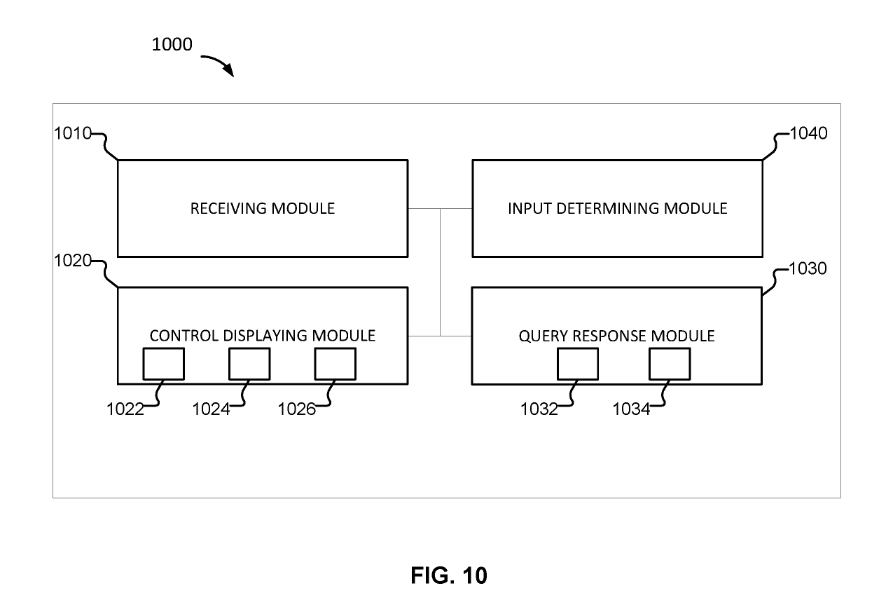

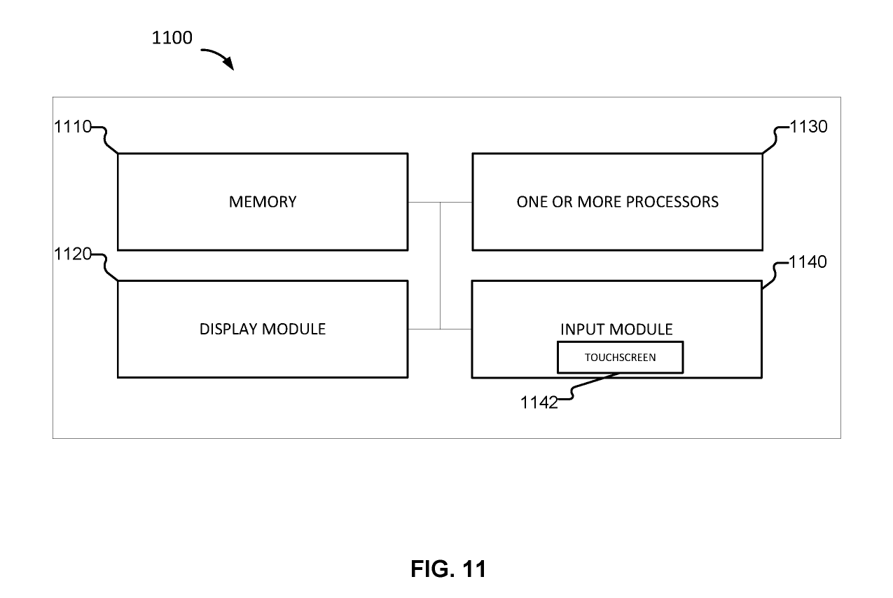

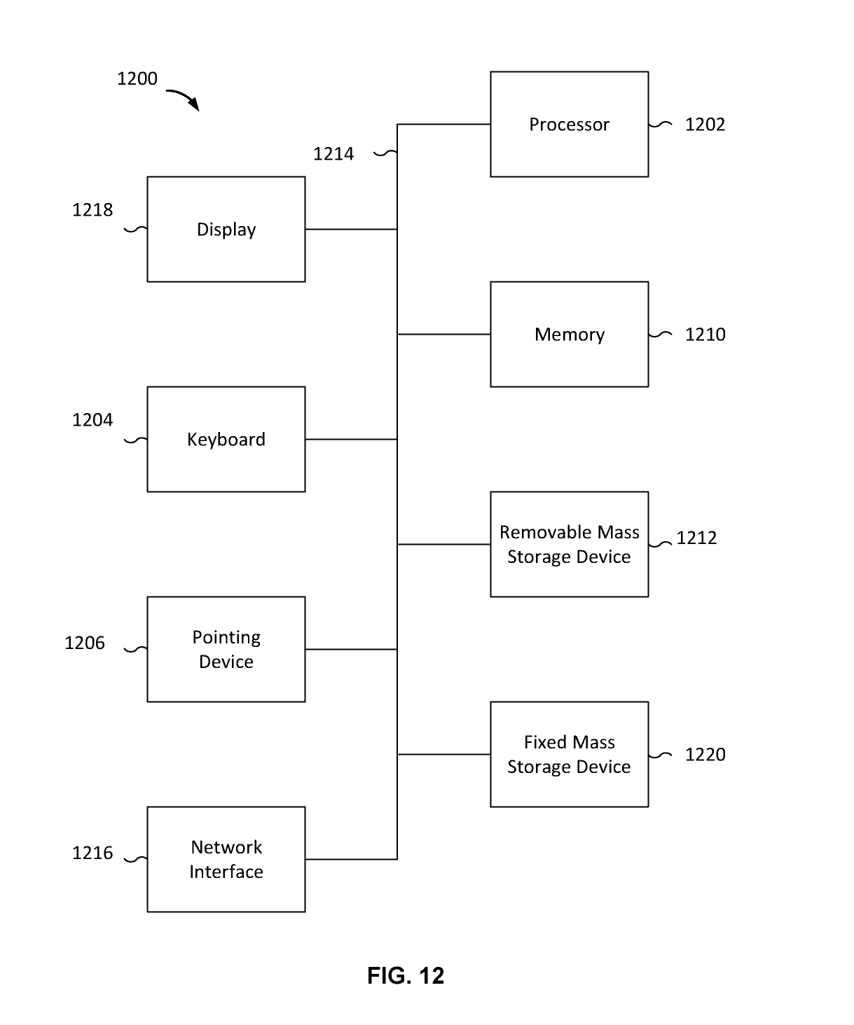

Referring to FIG. 1, process 100 for displaying information or interfaces in connection with a query is provided. Process 100 can be implemented to display screen 200 of FIG. 2, screen 500 of FIG. 5, and/or screen 700 of FIG. 7. Process 100 can be implemented by device 900 of FIG. 9, device 1000 of FIG. 10, and/or terminal 1100 of FIG. 11. Process 100 can be implemented by a computing system such as computer system 1200 of FIG. 12.

At 110, an input to an app is received. In some embodiments, an input to an app interface is received. The input can be to a non-control zone of the app interface. The app can be installed and executed on a terminal such as a smart terminal. In some embodiments, the non-control zone corresponds to an area of a graphical user interface displayed in connection with the app. The non-control zone can be an area in which there are no other elements that can be selected or activated in response to an input to the app or terminal. An app typically includes: control area, content display area, and blank area, and the control area is operable by the user (e.g., can receive inputs thereto) and is responsive to the application function corresponding to the control. For example: a short message interface includes: message content (e.g., a non-control area), reply button (e.g., a control area), back button (e.g., a control area), and input box (e.g., a control area). According to various embodiments, a non-control area corresponds to an area other than the control area.

At 120, it is determined whether to perform a query based at least in part on the received input. For example, it can be determined whether the received input corresponds to an input that is associated with the performing of a query. In some embodiments, a table or other database can be stored in which associations between inputs and corresponding functions or actions are mapped and stored. The determining of whether to perform the query based at least in part on the input can include determining whether the received input has a corresponding function or action mapped thereto (e.g., the corresponding function can be looked-up in the table storing the associations or mappings of inputs to functions). If a function is associated with the received input, it can be determined whether the function is a function for performing a query. The query can correspond to a query within the app or a global query on a terminal according to which information external to the app is searched or queried (e.g., subject to the query). In some embodiments, it can be determined whether a query is to be performed based at least in part on whether the input satisfies a preset query trigger condition. In some embodiments, the query can be a specific query according to which specific information is searched (e.g., according to predetermined query criteria). For example, the performing of the specific query in response to receiving the input can correspond to performing a query for specific product types in the event that the app being executed and/or displayed at the time the input is received corresponds to a purchasing app. In some embodiments, determining to perform the query based at least in part on the input can comprise determining that a query interface in which certain query criteria are to be input is to be displayed.

In the event that it is determined, based at least in part on the input, that a query is not to be performed at 120, process 100 can proceed to 130 at which no query is performed. For example, process 100 can end. In some embodiments, in the event that it is determined that a query is not to be performed in response to the input, the terminal can maintain its previous state and/or monitor for further inputs (and respond/act accordingly based on such further inputs). If the input does not correspond to a predefined input (e.g., an input, the receipt of which causes an instruction to perform a query to be generated), it can be determined that a query is not to be performed.

In the event that it is determined, based at least in part on the input, that a query is to be performed at 120, process 100 can proceed to 140. At 140, a system control is displayed. In some embodiments, in response to determining that the input satisfies a preset query trigger condition (e.g., that the input corresponds to an input associated with the calling of a query function), a system control is displayed. In some embodiments, the system control comprises interface elements related to the current app (e.g., the app being run or displayed when the input is received). The display of the system control can include obtaining one or more interface elements associated with the current app. The one or more interface elements can include query criteria according to which the query is to be performed. In some embodiments, the display of the system control can include performing a query based at least in part on the obtained one or more interface elements. In some embodiments, the query is performed against locally stored information such as data local to the app. The data can be preset or provided by an App data provider.

At 150, a query response interface is displayed. The query response interface can be displayed based at least in part on the query criteria (or query condition) corresponding to the one or more interface elements associated with the current app that are obtained. A query response can be obtained based at least in part on the one or more interface elements. For example, a query response interface can be obtained based at least in part on the one or more elements (e.g., a query response interface can be populated with query results based on the query performed). A query response interface obtained according to the query condition corresponding to the triggered (e.g., selected) interface element can be displayed.

In using a smart terminal, the user sometimes searches for needed information in an app. As an example, for an app corresponding to an address book or the like, the user can search for contact information of a certain contact within a list of contacts. As another example, in an app corresponding to photos or an object repository, the user can search for a photograph in a photo album. In performing such query processes according to conventional art, manual, one-at-a-time screening of information is often necessary. Such query processing is extremely time-consuming when the number of items being searched is large. According to various embodiments, a user query is assisted by a system control. For example, while in the process of being operated, the current app receives input in the app interface non-control zone. The current app or system control performs active detection of input to the current app based on the corresponding operation, such as an up, down, left, or right swipe executed by the input and actively predicts whether the detected input satisfies a preset query trigger condition (e.g., a condition the satisfaction of which causes the terminal or system control thereof to perform a query). Upon the preset query trigger condition being satisfied, it determines that the user is in need of assistance (e.g., is calling for a query to be performed or for the system control), and the system control can be displayed. For example, the system control can be automatically displayed in response to determining that the user is in need of assistance.

In some embodiments, the system control displays interface elements. The interface elements can assist the user in executing the appropriate function. For example, the interface elements can assist the user with the relevant query words for the query. As another example, the interface elements can invoke another app to assist with the query (e.g., to be executed in connection with performing the query). According to various embodiments, the interface elements are related to the current app and can assist the user in executing the query. The interface elements can correspond to suggested query criteria (e.g., the query words) based on the context of the terminal such as based on the current app. For example, the suggested query criteria can be determined according to information associated with the current app such as a type of app, information being displayed by the current app, or the like. Suggested query criteria can be stored in a table that stores associations or mappings of query criteria according to context (e.g., the current app, information being displayed, etc.).

In some embodiments, if the system control is displayed, the user can trigger an interface element within the system control for assistance with the query. The user can, via the system control, select an interface element, provide an input to the terminal, and/or input information associated with the query. For example, triggering the interface element within the system control can include one or more of selecting an interface element, providing an input to the terminal, and/or inputting information associated with the query. In some embodiments, a user can click on the interface element (e.g., a function button) on the system control. In the event that the user clicks on the interface element, the interface element is triggered. The system control can execute another function. For example, the system control can execute one or more other functions (e.g., functions other than performing the query) based on need of the user. The need of the user can be determined based at least in part on a context of the current app, the terminal, or the system control. The need of the user can be determined based at least in part on the input received that caused the system control to be called. As an example, the user can select recommended query key words and other such information corresponding to the interface element. The system control, based at least in part on the triggering of the interface element, can generate a corresponding query condition. The system control can process the query condition and communicate the query condition (e.g., query criteria, query word, or the like) to the current app to carry out an information query. In some embodiments, the system control can communicate the query condition to another app executed on the terminal or to a native function of an operating system of the terminal. In some embodiments, the current app displays the corresponding query response interface based on the query. For example, the current app can perform the query based at least in part on the query condition received from the system control, and can display the corresponding response interface. The query response interface can include one or more results of the query. In some embodiments, while the user is conducting the query, query key words and other such information can be recommended to the user through the system control so as to assist the user in executing the query. The recommendation of query key words and other such information can improve an efficiency of using the current app, perform a query within the current app, or the like.

In some embodiments, a current app receives an input to an app interface non-control zone; in response to receiving the input, the terminal determines whether the input satisfies a preset query trigger condition, and in the event that the input is determined to satisfy the preset query trigger condition, a system control is displayed. A query can be performed and the query response interface obtained according to the query condition corresponding to the triggered interface element can be displayed based at least in part on the triggering of the interface element associated with the current app. Various embodiments actively predict a query for the user based on current app input. For example, various embodiments actively display a system control and through an interface element of the system control provide a query condition to assist the user in querying. The efficiency of performing queries in a current app can thus be improved.

Various embodiments include a system control-based method for actively predicting and assisting users with querying.

In the process of using a smart terminal, a user may at any time and in any scenario initiate a system control. According to various embodiments, the system control is a personal assistant. For example, the system control can correspond to a personal assistant, in which case the personal assistant does serve as a single app. The system control can be called in any of various application scenarios to help the user. For example, the system control can be called in response to input of a predefined input. The predefined input can be configured based on manufacturing settings, user preferences, application settings, or the like. The system control can actively predict user needs and display information or functions that can be called to assist the user in completing specific functions (e.g., querying).

The system control can run in the background while various other apps are operated on the terminal.

In some embodiments, in the event that the system control is activated, the terminal (via its operating system) can detect a call for the system control in various application scenarios. The detecting of the call for the system control can be deemed a detection that a user has a need for assistance with querying or other such need. In each case, it can activate a personal assistant system control on its own. The system control can display different suggestion results according to the application scenario in which the current app is operated. For example, in the event that contact information is being queried in a contacts list, the terminal can detect that the user wants to perform a query (e.g., by detecting a predefined input in the current app associated with contact information) and, in response, activates the system control. As an example, the system control can recommend the last used contact (e.g., the last contact viewed, the last contact to which a communication is sent, etc.), a frequent contact (e.g., a frequently viewed contact, a contact to which a communication is communicated on a most frequent basis), and other such information. In some embodiments, the system control can receive speech input (e.g., voice commands from the user) in connection with executing the query.

FIG. 2 is a diagram of an interface according to various embodiments of the present application.

Referring to FIG. 2, interface 200 is provided. Interface 200 can be implemented by process 100 of FIG. 1, device 900 of FIG. 9, device 1000 of FIG. 10, terminal 1100 of FIG. 11, and/or a computing system such as computer system 1200 of FIG. 12.

Interface 200 can be displayed in connection with a user searching for an app in the terminal-displayed (e.g., smart terminal-displayed) system. For example, in the event that the terminal is requested to search for an app on the terminal, interface 200 can be displayed. The terminal can be requested to search for an app on the terminal in response to a predefined input by the user, or by a request generated by an app operating on the terminal.

Apps installed or otherwise available to the terminal (e.g., apps that can be installed from an app store, or the like) can be displayed on interface 200 in connection with a search for an app. For example, apps 220, 222, 224, 226, 228, 230, 232, and 234 can correspond to apps installed or otherwise available to the terminal and can be displayed on interface 200. The apps can be selected (e.g., via a touch to the corresponding location on the touchscreen). In response to the selection of an app, the selected app can be executed (or installed on the terminal if the app is not already installed on the terminal).

Query conditions (e.g., query criteria, query words, etc.) can be input to input element 210. The query conditions can be input via the touchscreen (e.g., a soft keyboard that is displayed on the touchscreen via which text can be typed by a user) or via a microphone. For example, if element 212 is selected, speech input to a microphone on the terminal can be used to input the query conditions. The terminal can perform speech-to-text processing on the speech input to the microphone, and use a result of such speech-to-text processing as the query conditions. In some embodiments, a user can edit the result of the speech-to-text processing before a query is performed.

In the event that a specific input is received based on the query for the user, interface elements can be determined. In some embodiments, interface elements related to the current interface information are determined, and a customized system control display interface is displayed. For example, interface elements associated with interface 200 can be determined. After the interface elements associated with interface 200 are determined, the system control display interface can be displayed. The system control display interface 250 can be customized based at least in part on the interface elements associated with interface 200. The customized system control display interface can be displayed as an overlay to the current interface (e.g., as an overlay to the interface 200 for searching for an app on the terminal). As illustrated in FIG. 2, the customized system control display interface 250 can be displayed in connection with interface 200 and can be customized to include elements 260, 262, 264, and 266. Elements 260, 262, 264, and 266 (e.g., apps corresponding to a result of the query) can be selected (e.g., via a touch to the corresponding location on the touchscreen or a voice command for a specific application such as “select photo app”). In response to selection of an app, the selected app can be executed (or installed on the terminal if the app is not already installed on the terminal).

Element 252 can be displayed on system control display interface 250. In response to selection of element 252, system control display interface 250 can be minimized (e.g., closed).

Element 254 can be displayed on system control display interface 250. In response to selection of element 254 (e.g., a swipe in a left or right direction), a set of query results displayed in system control display interface 250 can be scrolled through. For example, display element 254 can indicate that several pages of query results exist for the query performed via the system control.

In some embodiments, in the event that the current app is the system desktop, information tags can comprise at least one of the following: an entry tag for recommended apps and an entry tag for most often used apps; and the function buttons can comprise: a speech button (e.g., element 212). The most commonly used app can be determined based at least in part on a number of times one or more apps are used (e.g., selected) within a period of time. The most commonly used app can be determined based at least in part on an amount of time one or more apps are operated within a period of time. In some embodiments, an app recommendation can be based on user need, app type, and so on. For example, a utility app or a communication app may be recommended. The app recommendation can be included in system control display interface 250.

For example, the system control displays information tags corresponding to “Settings,” “Cloud Photo Album,” “Music,” “TTS4.0,” (respectively illustrated as elements 260, 262, 264, and 266), and other such information tags. In the lower-right corner of system control display interface 250, a function button (e.g., element 256) can be displayed. The function button can correspond to a button configured as a speech button or a camera (e.g., image capture) button so that the user may directly carry out speech input or take a picture. Thus, the user can select an information tag within the system control (e.g., element 260, 262, 264, or 266 displayed on system control display interface 250) or a function button to trigger a corresponding query condition. The system control assists the user in performing the query. For example, in the event that the user clicks on the “Settings” information tag (e.g., element 260), the query condition for a query setting can be generated. A message (or instruction) is communicated to the system desktop (e.g., via system call indicating that the “Settings” information tag is selected). In response, the system desktop activates the settings (e.g., an app for terminal settings) and the system control is exited (e.g., the system control display interface 250 is no longer displayed). As another example, in the event that the user records “Tell a joke” using the speech button, the system control can generate a query-speech interaction message based on this speech input and communicate the message (or instruction) to the system desktop. The recording of “Tell a joke” can correspond to a query condition used in connection with performing a query. The system control can determine that the speech input (e.g., recording of “Tell a joke”) corresponds to Siri™ or other such application. For example, Siri™ or other such application can be a query result based on a lookup performed by the system control. The instruction can include an indication that the called function is to be Siri™ or other such application. In response to receiving the message, the system desktop activates Siri™ or other such application.

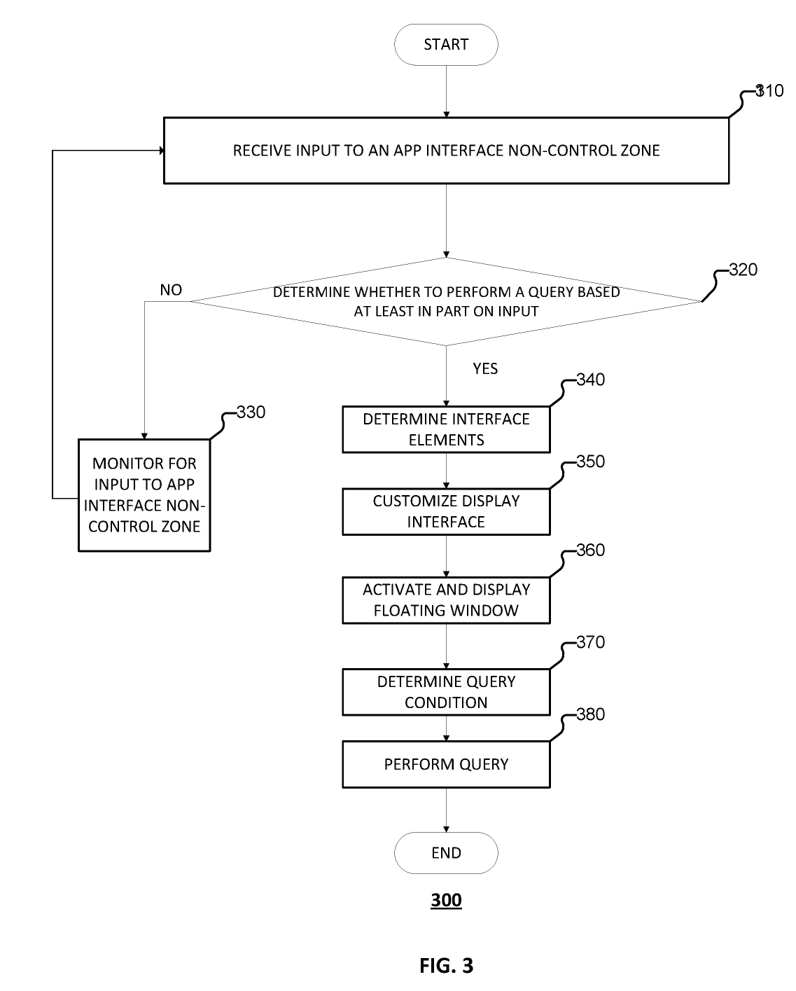

FIG. 3 is a flowchart of a method for data processing according to various embodiments of the present application.

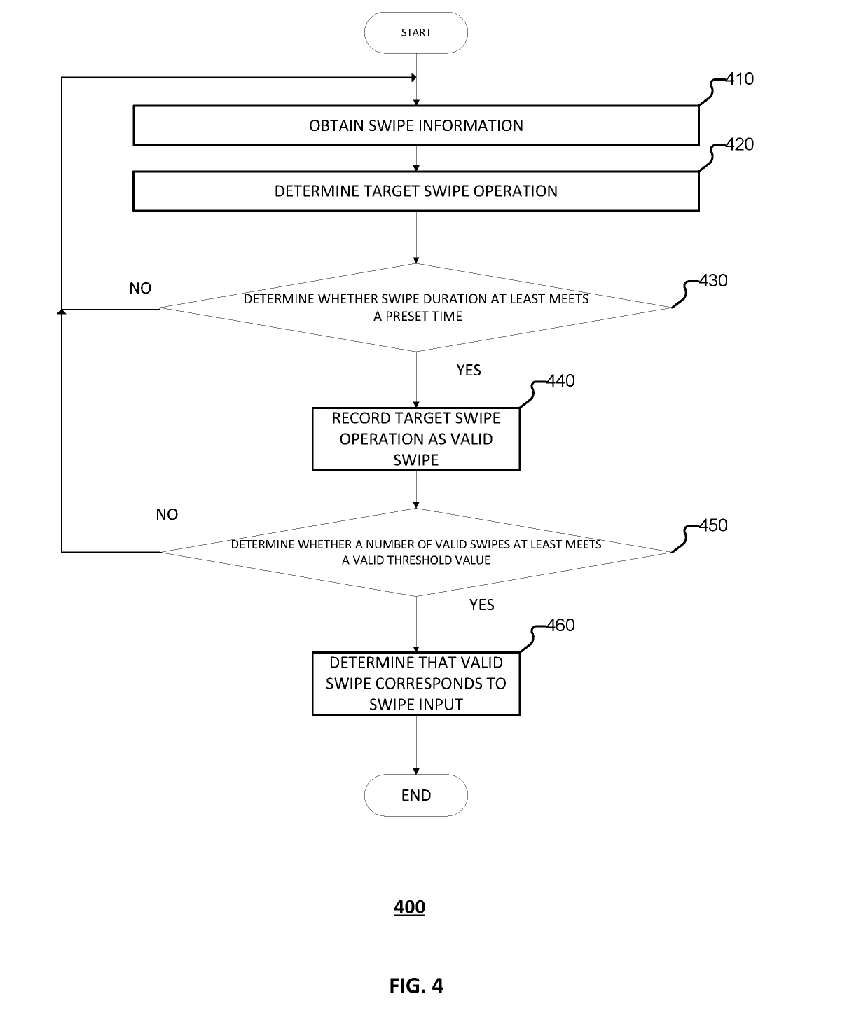

Referring to FIG. 3, process 300 for displaying information or interfaces in connection with a query is provided. Process 300 can be implemented to display screen 200 of FIG. 2, screen 500 of FIG. 5, and/or screen 700 of FIG. 7. Process 300 can implement process 400 of FIG. 4. Process 300 can be implemented by device 900 of FIG. 9, device 1000 of FIG. 10, and/or terminal 1100 of FIG. 11. Process 300 can be implemented by a computing system such as computer system 1200 of FIG. 12.

At 310, an input to an app is received. In some embodiments, an input to an app interface is received. The input can be to a non-control zone of the app interface. The app can be installed and executed on a terminal such as a smart terminal. In some embodiments, the non-control zone corresponds to an area of a graphical user interface displayed in connection with the app. The non-control zone can be an area in which there are no other elements that can be selected or activated in response to an input to the app or terminal. In some embodiments, a terminal polls for an input to the terminal. For example, the operating system or the like of the terminal can detect an input and provide the input to the current app.

At 320, it is determined whether to perform a query based at least in part on the received input. For example, it can be determined whether the received input corresponds to an input that is associated with the performing of a query. In some embodiments, a table or other database can be stored in which associations between inputs and corresponding functions or actions are mapped and stored. The determining of whether to perform the query based at least in part on the input can include determining whether the received input has a corresponding function or action mapped thereto (e.g., the corresponding function can be looked up in the table storing the associations or mappings of inputs to functions). If a function is associated with the received input, it can be determined whether the function is a function for performing a query. The query can correspond to a query within the app or a global query on a terminal according to which information external to the app is searched or queried (e.g., subject to the query). In some embodiments, it can be determined whether a query is to be performed based at least in part on whether the input satisfies a preset query trigger condition. In some embodiments, the query can be a specific query according to which specific information is searched (e.g., according to predetermined query criteria). For example, the performing of the specific query in response to receiving the input can correspond to performing a query for specific product types in the event that the app being executed and/or displayed at the time the input is received corresponds to a purchasing app. In some embodiments, determining to perform the query based at least in part on the input can comprise determining that a query interface in which certain query criteria are to be input is to be displayed.

In some embodiments, an input for calling the system control can correspond to a predefined number of swipes. For example, the predefined number of swipes can correspond to a plurality of swipes that are identical or similar (e.g., in the same direction). The associated input with the performing of a query can correspond to the predefined number of swipes. At 320, it can be determined whether the received input corresponds to the predefined number of swipes. In the event that the predefined number of swipes (e.g., multiple identical or similar swipe inputs) is received, it can be deemed that the user is requesting to call a query function (e.g., that the user has a query need). Various inputs can be set to correspond to the input for calling the system control or for indicating a request to perform a query in the current app. For example, the input can include at least one swipe input. The swipe input can be a swipe operation performed by the user with the user's finger or a touch pen on a touchscreen. In some embodiments, the system control can be affirmatively activated to assist with the query. For example, the system control can be affirmatively activated by clicking a floating button (e.g., a button that floats or is overlaid on an interface of the terminal such as the interface for the current app) or by a double tap on the touchscreen. The corresponding system control may be configured with a floating button or some other fast activation icon. In the event that the floating button is clicked, the system control can be activated. Various preset operations can be set to serve as the specific input. Examples of such various preset operations include a double-tap operation on the touchscreen or a press-and-hold operation on the touch screen, etc.

Various embodiments can detect multiple inputs (e.g., that can collectively be deemed one input, such as multiple swipes), and based on the detection of the multiple inputs, deem that the user intends to perform a query. For example, in order to accurately determine the user's query need, in response to detecting multiple consecutive swipe operations, it can be determined whether the multiple consecutive swipe operations satisfy the preset query trigger condition. In some embodiments, swipe information is obtained from a touchscreen, and the swipe information serves as a basis for determining whether the input satisfies a preset query trigger condition. For example, the terminal can determine whether to perform a query based at least in part on the swipe information. The swipe information from the touchscreen can be obtained by adding code in the system (e.g., by configuring the operating system, adding code to an operating system codebase, or the like). Swipe information can be information such as swipe distance, swipe direction, swipe duration, swipe location, etc. The swipe information for a plurality of swipe inputs can be used individually or collectively to determine whether the preset query trigger condition is satisfied by at least one of the plurality of swipe inputs. The terminal can determine whether the input corresponds to a request to perform a query (e.g., whether the input satisfies the preset trigger condition), based at least in part on one or more of the swipe distance, swipe direction, swipe duration, swipe location, etc.

FIG. 4 is a flowchart of a method for data processing based on a swipe input according to various embodiments of the present application.

Referring to FIG. 4, process 400 for data processing based on a swipe input is provided. Process 400 can be implemented to display screen 200 of FIG. 2, screen 500 of FIG. 5, and/or screen 700 of FIG. 7. Process 400 can be implemented in connection with process 300 of FIG. 3. Process 400 can be implemented by device 900 of FIG. 9, device 1000 of FIG. 10, and/or terminal 1100 of FIG. 11. Process 400 can be implemented by a computing system such as computer system 1200 of FIG. 12.

At 410, swipe information is obtained. In some embodiments, the swipe information is obtained from the touchscreen. The touchscreen can include one or more sensors that monitor for inputs and collect information associated with an input (e.g., a swipe). In some embodiments, the swipe information can include swipe distance, swipe direction, swipe duration, swipe location, etc. The swipe information can be obtained by the system control, an operating system running on the terminal, or the like.

At 420, a target swipe operation can be determined. The target swipe operation can be determined based at least in part on the swipe information. For example, the target operation can be determined based at least in part on the swipe direction. The target swipe operation can correspond to a preset operation that is associated with an input corresponding to (e.g., matching) the swipe information. For example, the terminal can store a table storing mappings or associations between inputs (e.g., swipe information parameters corresponding to the inputs) and predefined operations (e.g., a touch and hold operation, a tap, a swipe in an up, down, right, or left direction, etc.). The mappings or associations between inputs and predefined operations can also be associated with an app. For example, an upward swipe in an address book app can be stored separately from an upward swipe in a photo album app.

At 430, it can be determined whether at least a part of the swipe information at least meets one or more preset thresholds. For example, it can be determined whether a swipe duration corresponding to the input at least meets a preset time. The preset time can be a threshold that is configurable. For example, the preset time can be configured based on user preferences, manufacturer settings, app settings, or the like.

The swipe information can be obtained based at least in part on the swipe operation (e.g., a target swipe operation) on the touchscreen. The obtaining of the swipe information can include, or otherwise correspond to, determining the swipe information to be the swipe direction and swipe distance based on each coordinate on the swipe path. Based on the swipe direction, a current swipe operation can be determined to be the target swipe. For example, the target swipe operation can be determined to be an upward or downward swipe in a contacts app. As another example, the target swipe operation can be determined to be a left swipe or right swipe operation on a desktop.

The obtaining of the swipe information can include, or otherwise correspond to, determining a swipe duration of the swipe operation. For example, determining the swipe information can include determining the swipe duration. In response to determining the swipe distance and direction, a swipe duration can be determined. The swipe duration can be the time from the start of swiping to the current swiping position. For example, the swipe duration can be an amount of time that a touch is engaged with the touchscreen (e.g., a time between when the touch contacts the touchscreen and when the touch is lifted from the touchscreen). It can be determined whether the swipe duration of the target swipe operation has exceeded the preset time.

In the event that the swipe duration does not at least meet the preset time, process 400 can end. In some embodiments, in the event that the swipe duration does not at least meet the preset time, process 400 can proceed to monitor for inputs (e.g., swipes) and collect (e.g., recording) swipe information corresponding to the inputs. In some embodiments, in the event that the swipe duration does not at least meet the preset time, then process 400 can proceed to continue to determine the swipe duration.

In some embodiments, in the event that the swipe duration is determined to at least meet the preset time, process 400 can proceed to 440. At 440, the target swipe operation is stored. In some embodiments, the target swipe operation is recorded as a valid input. The target swipe operation can be recorded in RAM of the terminal.

In the event that the swipe duration of the target swipe operation at least meets a preset time, the swipe corresponding to the swipe information can be determined to be a single valid swipe (e.g., a single valid input corresponding to the target swipe operation). As an example, in the event that the target swipe operation corresponds to two consecutive downward swipes, if the swipe duration of the target swipe operation at least meets the preset time, then the two consecutive downward swipes can be deemed to be a single valid input.

Various embodiments can compare characteristics of inputs other than swipes in a similar manner. For example, a target operation is not limited to a target swipe operation. In some embodiments, rather than obtaining swipe information, input information can be obtained. For example, in the event that the target operation is a touch and hold, input information including a location of a touch, a duration of the touch, a pressure of the touch, or the like can be obtained.

At 450, it can be determined whether a number of recorded valid swipes at least meets a valid threshold value. For example, it can be determined whether the number of corresponding instances of the valid input of the target swipe operation at least meets a valid threshold value.

According to various embodiments, in connection with determining a user's need (e.g., a function being requested by the user based on input to the terminal), if it is determined that the user has failed to find the needed information after several search attempts, a function, such as a search function, can be improved by using the system control to provide the user with assistance. If the user finds the needed information on the first try, then the system control is not used to provide assistance (e.g., providing assistance via the system control may be unnecessary). As an example, in a system where the valid threshold value is two, if a user is operating an address book to search for a contact and the user inputs two downward swipes in connection with the search for the contact, the system control may be activated. In the event that the system control is activated, the system control can provide assistance with the search.

According to various embodiments, the number of valid swipes may be set for the target swipe operation. At the start time, the number of swipes is set at 0. Each time a valid input is detected, then 1 is added to the number of swipes. It is then determined whether the number of corresponding instances of valid input of the target swipe operation at least meets the valid threshold value.

In the event that the number of recorded valid swipes at least meets the valid threshold value, then process 400 can proceed to 460. For example, if the number of corresponding instances of the valid input of the target swipe operation at least meets the valid threshold value, then process 400 can proceed to 460.

At 460, the valid swipe is determined to correspond to a swipe input. In some embodiments, in the event that the valid swipe is determined to correspond to the swipe input, the swipe input can be deemed to satisfy a preset query trigger condition. In some embodiments, the preset query trigger condition can correspond to one or more criteria, the satisfaction of which is deemed to correspond to a request to perform a query. For example, in the event that the preset query trigger condition is satisfied, a query can be triggered. Triggering of the query can include performing a query based at least in part on one or more query words, query criteria, query conditions, or the like. Triggering of the query can include activating the system control to perform a query.

In the event that the number of recorded valid swipes does not at least meet the valid threshold value, then process 400 can continue to determine the swipe duration. In some embodiments, in the event that the number of recorded valid swipes does not at least meet the valid threshold value, process 400 end. In some embodiments, if the number of corresponding instances of the valid input of the target swipe operation does not at least meet the valid threshold value, then process 400 can proceed to monitor for inputs (e.g., swipes) and collect (e.g., recording) swipe information corresponding to the inputs. In some embodiments, if the number of corresponding instances of the valid input of the target swipe operation does not at least meet the valid threshold value, then process 400 can proceed to 430 for continued determination of the swipe duration.

According to various embodiments, if the number of corresponding instances of valid input of the target swipe operation at least meets the valid threshold value, then it can be determined (e.g., deemed) that the user has a query need and has failed to find the needed information. In such an event, the valid input can be deemed to satisfy a preset query trigger condition. In some embodiments, a single valid swipe can be regarded as a single swipe input. For example, the valid threshold value can be set at 0. Accordingly, system control is displayed (e.g., triggered or activated) after it is determined that more than one swipe input has been received. The valid threshold value can be set according to manufacturer settings, user preferences, app settings, or the like. The valid threshold value can be different among different apps.

An action can be triggered by a target swipe and/or a system gesture. For example, the PhoneWindow.java file can store code for determining whether a target swipe or a system gesture is detected and in the event that the target swipe or system gesture is detected, the corresponding action can be triggered. In some embodiments, a segment of gesture-assessing code is added into the operating system in the PhoneWindow.java file in an operating system such as the YUNOS system for determining whether an input corresponds to a swipe from the bottom of the screen, etc. If the condition is met (e.g., in the event that the input is determined to correspond to a swipe from the bottom of the screen), the startService method is used to activate a system control such as a personal assistant control. The personal assistant control can be a system-level user assistant control. The personal assistant control can assist the user in executing various operations, such as a speech input operation or a command input operation.

In some embodiments, PhoneWindow.java is the parent (e.g., the parent view) of all views on a smartphone. In some embodiments, inputs such as touchscreen operations (e.g., touch events) are communicated to the parent view before the corresponding child view. For example, a touch screen operation is first transmitted to the parent view and then transmitted to the child view of the parent view. Thus, it is possible to capture the user's gesture operation in the parent view, thereby making activation of the personal assistant control (e.g., the system control) in any scenario and thus systematize the personal assistant control. For example, an intercept can be generated in the parent view and the interception can implement a system control.

If it does (e.g., in the event that it is determined that the input satisfies a preset query trigger condition), process 300 can proceed to 340. If it does not (e.g., in the event that it is determined that the input does not satisfy a preset query trigger condition), process 300 can proceed to 330.

Returning to process 300 of FIG. 3, at 320, it is determined whether a query is to be performed based at least in part on the input. For example, determining whether to perform the query based at least in part on the input can include determining whether a query trigger condition is satisfied based at least in part on (e.g., by) the input. Determining whether the query trigger condition is satisfied based at least in part on the input can be implemented according to process 400 of FIG. 4.

In the event that it is determined not to perform a query based at least in part on the input (e.g., that the query trigger condition is not satisfied), process 300 can end. In some embodiments, in the event that it is determined not to perform the query based at least in part on the input, process 300 can proceed to 330 at which an input interface (e.g., the touchscreen or the like) is monitored for an input to an app interface non-control zone.

In the event that it is determined to perform the query based at least in part on the input (e.g., that the query trigger condition is satisfied), process 300 can proceed to 340. At 340, one or more interface elements are determined. For example, the one or more interface elements associated with the current app are determined. The interface elements can be determined based on one or more of a type of the current app, metadata associated with the current app, characteristics or features of the current app, etc. The determining of the one or more interface elements can comprise obtaining an app package name of the current app, and determining the one or more elements based at least in part on the app package name of the current app. The determining of the one or more elements can comprise determining, based at least in part on the app package name of the current app, one or more of an information tag, a function button, etc.

At 350, a display interface is customized. The display interface for the system control can be determined. For example, the display interface for the system control can be customized based at least in part on the one or more interface elements.

At 360, a floating window is activated and displayed. For example, the system control can be displayed. The system control can be displayed in the floating window. The floating window can be overlaid in relation to the current app (e.g., the interface of the current app). Activating the floating window can include displaying the floating window with the app interface of the current app as the background.

A terminal can receive an input when a current app is being operated, when a desktop of the terminal is being displayed or operated, or the like. In some embodiments, the one or more interface elements displayed by the system control can be related to (e.g., based at least in part on) the current app. Therefore, when an app is currently running, obtaining the app package name is possible. When the app is currently located in a system interface such as the system desktop, obtaining interface information is possible. For example, when the app is located on the main interface or an app display interface, the interface information can be obtained. The interface elements can be determined based at least in part on one or more of the app package name or interface information. In some embodiments, interface elements include tag information and/or a function button. The interface elements can be in various formats such as an ICON plus text or a tag information format.

In some embodiments, an information tag includes recommended tag information. For example, the information tag can be set based at least in part on historical use data corresponding to the current scenario. Tag information set based at least in part on the historical use data can include frequently accessed contacts, frequently dialed numbers, bookmarked pages, etc. As an example, the information tag can include app function entries, recommended options, etc. Therefore, the information tag can be used to execute the appropriate function in the current app, or it is possible to jump to (change the currently operating or currently displayed app to) another app.

In some embodiments, the function button can be associated with the current app. For example, the function button can be a function that is provided by the current app. In some embodiments, the function button is unrelated to the current app. As an example, function buttons can include speech buttons, picture-taking buttons, power-off buttons, etc.

In the present embodiment, the system control display interface is customized according to the one or more interface elements. Thus, the current app-related interface element can be displayed in the system control display interface. The system control display interface can also include some general interface elements (e.g., interface elements that are not specifically related to the current app). In the event that the system control is triggered or activated, the floating window is activated. The floating window is displayed as an overlay to the current app, or otherwise includes the current app as a background. Thus, the floating window is activated with the app interface of the current app as the background, and the display interface of the system control is displayed in the floating window.

In some embodiments, the base level of a system control such as personal assistant control is implemented as a service. Therefore, the system control can be activated using the command or call “startService.” In the event that the control is activated, the package name of the current app (activity) can be acquired. A different display interface can be created based on the package name so as to display a customized system control.

FIG. 5 is a diagram of an interface according to various embodiments of the present application.

Referring to FIG. 5, interface 500 is provided. Interface 500 can be implemented by process 100 of FIG. 1, process 300 of FIG. 3, device 900 of FIG. 9, device 1000 of FIG. 10, terminal 1100 of FIG. 11, and/or a computing system such as computer system 1200 of FIG. 12.

Interface 500 can correspond to an app for system settings. For example, when the current app (e.g., the app currently being operated and displayed by the terminal) corresponds to the app for system settings, interface 500 can be displayed. System control display interface 550 can be displayed. In the event that the current app corresponds to a system settings app, interface 500 can include features provided by the system settings app. For example, interface 500 can include element 510 corresponding to a feature for Bluetooth settings, element 515 corresponding to a feature for WiFi settings, and element 520 corresponding to a feature for other data connection settings.

System control display interface 550 can include information tags that are elements corresponding to features or functions associated with the system settings app and/or elements corresponding to features or functions that are not specifically associated with the system settings app (e.g., photos, storage, etc.).

In the event that the current app is system settings, the information tags comprise at least one of the following: an entry tag for recommended settings, an entry tag for most often modified settings, and the function buttons, comprising: a speech button. The system device can be viewed as a type of system app. The recommended settings can be recommended (e.g., determined) based on user need, historical use, etc. Examples include Bluetooth, WiFi, and other data connection settings. The most commonly modified settings can be a device setting that, historically (e.g., statistically), the user selects or modifies often within a period of time. In some embodiments, to adjust system settings, the user inputs a target input as an upward swiping gesture. The terminal can determine a system setting-related interface element based at least in part on the features or functions for which a user has historically input an upward swiping gesture. Detection of a downward swiping gesture can similarly be used to determine a system setting-related interface element. For example, some functions in the system settings can be determined to be information tags, including “Wallpaper,” “Ringtone,” “Account,” and “Storage.” A speech button for receiving speech input can also be set.

The system control display interface 550 can include elements corresponding to functions in the system settings that are determined to be information tags. For example, as illustrated in FIG. 5, system control display interface 550 can include an element 552 corresponding to “Wallpaper,” element 554 corresponding to “Sound,” element 556 corresponding to “Account,” and element 558 corresponding to “Storage.” Selection of any of elements 552, 554, 556, or 558 can cause the corresponding feature or function to be executed. For example, selection of element 552 corresponding to “Wallpaper” can cause the current app (e.g., the system settings app) to display information associated with wallpaper settings.

Returning to process 300 of FIG. 3, at 370, a query condition is determined. In some embodiments, the query condition for the current app can be determined based on the triggering of the interface element. An interface element can be triggered by selecting the interface element. For example, the interface element can be selected by a user clicking or otherwise inputting an input to the interface element.

In some embodiments, the system control generates an appropriate query condition. For example, the system control can generate the query condition in connection with assisting the user with executing the query operation. In some embodiments, an interface element in the system control can be selected, query data such as key words (e.g., based on the interface element) can be received, and the appropriate query condition can be generated. In some embodiments, if the triggered (e.g., selected) information tag is a recommendation tag for a function entry of an app, then the query condition for this query function entry is generated. In some embodiments, if the triggered (e.g., selected) information tag is a recommendation tag for query key words in the current app, then the query key words corresponding to the triggered information tag are obtained to generate a query condition including the query key words associated with the recommended tag. In some embodiments, if the triggered (e.g., selected) function button is a speech button, then recorded speech signals are received and used to determine the query data and generate the query condition. In some embodiments, the key words can be an information tag associated with the app. The key words can be one or more common words associated with the function of the interface element.

In some embodiments, information tags include query tags and recommendation tags for function entry. The information tags, or an element associated therewith, can be displayed on the system control display interface. The function buttons include a speech button and a camera (e.g., image capture) button. With regard to different information tags and function buttons, different approaches can be taken to generate query conditions to help users with their queries.

In the event that an information tag is a query tag, the determining of the query condition for the current app based on selection of the information tag comprises: in response to a selection of the query tag, receiving query key words and generating a query condition for the current app based at least in part on the query key words The query keywords can be obtained or generated according to the current app.

In some embodiments, the query tag could provide the user with query key words. For example, the query tag can display query key words from which a user can select a query key word to perform a query on. Query key words that can be provided to the user can include information on frequent contacts displayed in a contacts app or a contacts group. Accordingly, in the event that the query tag is selected (e.g., by the user), a query regarding the query key words can be initiated and/or performed. For example, in response to selection of the query tag, a query based at least in part on one or more of the query key words can be triggered. In response to the query tag being selected, the query key words corresponding to the query tag are received, and the query key words can be used to generate the query condition. A query can be performed based at least in part on the query condition. Accordingly, query recommendations can be provided to a user in connection with a query.

In the event that the function button is a speech button, the determining of the query condition for the current app based at least in part on the selecting of the interface element can comprise one or more of, in response to the speech button being selected, receiving speech signals, recognizing the speech signals, determining query key words based at least in part on the speech signals, and generating a query condition for the current app based at least in part on the query key words.

The user can select the speech button to record speech signals. The system control receives the appropriate speech signals on the basis of the selecting of the speech button. In the event that the speech signals are received, the speech signals can be identified. For example, feature extraction, matching, and other operations can be performed on the speech signals to recognize the corresponding text data. For example, speech-to-text processing can be performed and one or more query key words can be extracted therefrom. The text data can be used as a basis for determining the query key words. For example, the key words can be extracted from the text data based on an analysis of the text data based at least in part on natural language understanding. The query key words can be used to generate the query condition.

In the event that the information tag is a recommendation tag for function entry, the generating of the query condition for the current app based at least in part on the selection of the interface element can comprise receiving function entry information in response to selection of the information tag, and generating a query condition for the current app based at least in part on the function entry information. The function entry information can be obtained from the operating system of the terminal.

In some embodiments, an app can be located and operated or one or more functions provided by the app can be searched. Therefore, the information tag can correspond to being a recommendation tag for function entry. For example, in the system settings of FIG. 5, the function entry for each setting option may correspond to a recommendation tag. In the event that the recommendation tag is clicked (e.g., selected), the appropriate function entry can be determined and the function can be entered. For example, the function entry can include a text box and/or a soft keyboard via which the user can enter text corresponding to a function entry information. Therefore, as a result of selecting the information tag (e.g., the recommendation tag), the function entry information is received and the function entry information is used to generate a query condition.

At 380, a query is performed. A query response can be displayed in the event that the query is performed. In some embodiments, the query can be performed based at least in part on the query condition. In some embodiments, performing the query includes querying information in the current app using an application programming interface (API) provided by the operating system and/or the current app. In some embodiments, performing the query includes querying information stored locally at the terminal. In some embodiments, performing the query includes communicating with a remote database and querying the remote database (e.g., querying a remote storage).

In response to performing the query, a response to the query can be obtained. The response to the query based at least in part on the query condition can include query results. The current app can serve as the processor of the query condition, and on this basis, the query can be executed and the appropriate query response interface can be displayed.

In some embodiments, performing the query based at least in part on the query condition can include providing the query condition to the current app, the current app obtaining query key words corresponding to the query condition (e.g., by extracting the query key words from the query condition), and executing a query based at least in part on the query key words.

In the event that the current app is a contacts app, a photo album app, or some other such app, the user generally wants to query information in the current app. Therefore, the system control provides (e.g., sends) the query condition to the current app. The current app acquires query key words from the query condition and uses the query key words as a basis for querying the information. For example, the current app can search contact information, chat records, photographs, etc. based at least in part on the query key words, and can display the appropriate query results.

In some embodiments, it is determined (e.g., by the system control) whether the current app can process the query condition. The current app can determine whether it is able to process the query condition. For example, it can be determined whether the query associated with the query condition is for the current app. For example, it can be determined whether the query based at least in part on the query condition is directed to information that is provided or is accessible by the current app. As another example, it can be determined whether the query based at least in part on the query condition is a type of query that is processed by the current app. If the current app can process the operation instruction corresponding to the query, the query condition is distributed to the current app, and the system control is exited. In the event that the current app can process the operation instruction corresponding to the query, the current app executes the operation instruction. If the current app cannot process the query condition, the system control can itself execute the query condition and search for the appropriate information. For example, in the case of a query condition generated from the triggering of a function entry recommendation tag, the system control can itself activate the app or app function corresponding to the function entry. If the system control can open its own homepage, the homepage displays various assistance functions available to the user. In some embodiments, the assistance functions can correspond to a personal assistant such as Siri™ offered by Apple Inc. or Alexa™ offered by Amazon.com, Inc. Then it exits the system control. The homepage can provide assistance to the user (e.g., via the display of the various assistance functions). As another example, in the event that a query condition is generated from selection of a recommendation tag corresponding to a function entry, the recommendation tag can include app information. Therefore, the target app corresponding to the app information can be determined. In response to selection of the recommendation tag (e.g., a recommended information tag displayed on the system control display interface), a target app can be determined and operated, and the system control can be exited. The target app can query corresponding to the query condition.

In some embodiments, querying the query condition and displaying the corresponding query response interface comprises: communicating, or otherwise providing, the query condition to the current app; obtaining, by the current app, the function entry corresponding to the query condition; entering the function entry; and displaying the display interface corresponding to the function entry. In the event that the query condition includes function entry information on the app, a corresponding function in the app is generally operated. In some embodiments, the function entry corresponds to a function entry of the current application. For example, the application responds to the instruction entering the function entry. The application enters the function entry and displays the corresponding interface of the function entry. Therefore, the system control can determine the function entry information corresponding to the app information. The system control can communicate, or otherwise provide, the query condition to the current app and the system control is exited. The current app can obtain the function entry based at least in part on the query condition. In the event that the current app obtains the function entry, the current app can enter the function entry. In some embodiments, the function entry corresponds to a request to operate a function of the corresponding app. The function entry can be a request to operate a certain function provided by the app. For example, the function entry can be a function call. The current app can display the display interface corresponding to the function entry. For example, if the function entry for entering Bluetooth Settings is communicated to System Settings (e.g., the app for System Settings), then the app can be directed to the Bluetooth Settings page thereof.

Because the system control is a system-level assistant control, user query needs can be automatically detected in various query scenarios, and display interfaces can be customized for the corresponding different query scenarios. As a result, in the event that a user needs assistance in a query scenario (e.g., inputs a predefined input that is deemed to correspond to a user's need for assistance in a query), assistance is actively provided to the user for completion of the query operation. A personal assistant, being a system-level control, can have in-depth interactions with the app.

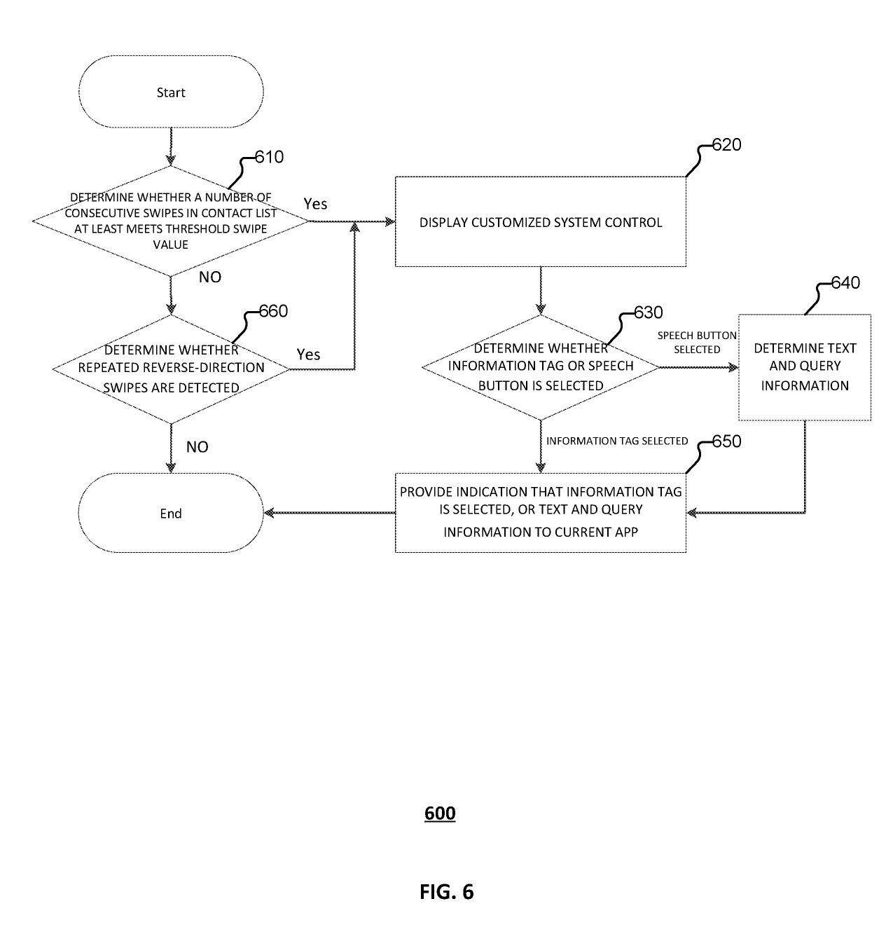

FIG. 6 is a flowchart of a method for data processing based on an input according to various embodiments of the present application.

Referring to FIG. 6, process 600 for displaying information or interfaces in connection with a query is provided. Process 600 can be implemented to display screen 200 of FIG. 2, and/or screen 700 of FIG. 7. Process 600 can implement process 300 of FIG. 3 and/or process 400 of FIG. 4. Process 600 can be implemented by device 900 of FIG. 9, device 1000 of FIG. 10, and/or terminal 1100 of FIG. 11. Process 600 can be implemented by a computing system such as computer system 1200 of FIG. 12.

At 610, it can be determined whether a number of consecutive swipes input in connection with the display of a contact list (e.g., by an address book app or the like) at least meets a threshold swipe value. The determination of whether the number of consecutive swipes at least meets the threshold swipe value can be performed by the system control, a system-level module, and/or the operating system of the terminal. The determining of whether the number of consecutive swipes at least meets the threshold swipe value can include determining whether an input to the terminal (e.g., the touchscreen) corresponds to a swipe (e.g., based at least in part on swipe information). The threshold swipe value can be configurable. For example, the threshold swipe value can be set according to manufacturer settings, user preferences, app settings (e.g., settings for the current app), etc.

In the event that the number of consecutive swipes input in connection with the display of the contact list at least meets the threshold swipe value, process 600 can then proceed to 620. At 620, a customized system control can be displayed. Display of the customized system control can be based at least in part on the current app (e.g., the address book app), historical use data (e.g., of the current app, or of the terminal, generally), swipe information corresponding to the one or more consecutive swipes, etc.

In the event that the number of consecutive swipes input in connection with display of the contact list does not at least meet the threshold swipe value, then process 600 can proceed to 660. At 660, it can be determined whether repeated reverse-direction swipes are detected. A reverse-direction swipe can correspond to a back-and-forth swipe such as an up-and-down swipe, or a right-and-left swipe. For example, a reverse-direction swipe can include a sequence of two or more swipes having a swipe in a first direction and another swipe that is in a second direction that is a reverse direction in relation to the first direction. In some embodiments, it is determined whether a threshold value (or more) of reverse-direction swipes is detected. Detection of a threshold value of reverse-direction swipes can be deemed an indication that the user needs assistance (e.g., that the user wants to activate/display the system control or that the user wants to perform a query). In the event that it is determined that repeated reverse-direction swipes are not detected at 660, then process 600 can end. In the event that it is determined that repeated reverse-direction swipes are detected at 660, then process 600 can proceed to 620.

In the event that the customized system control is displayed, at 630 it can be determined whether an information tag or a speech button is selected. For example, it can be determined whether an input is made to the system control. The information tag and the speech button can be included in the customized system control.

In the event that it is determined that the information tag or the speech button is selected at 630, process 600 can proceed to 640 at which text and query information can be determined. For example, the text and/or query information can be obtained based at least in part on the selected information tag or speech button. In the event that the information tag or the speech button is selected, a speech recording can be input to a microphone of the terminal and the obtained speech recording can be processed (e.g., using speech-to-text processing) and text and/or query information can be obtained. Thereafter, process 600 can proceed to 650.

In the event that an information tag is selected at 630, process 600 can proceed to 650.

At 650, a current app can be provided with an indication that the applicable information tag is selected (e.g., as determined at 630), or with text and query information (e.g., as obtained and determined at 640 based on selection of the speech button at 630).

In view of the above, in the example of searching contact information within a contacts list (e.g., in an address book app), as shown in FIG. 6, a user can swipe up or down in the contacts list searching for a contact. However, the contacts list may have a large number of contacts. Because the contacts list has a large number of contacts, searching for a particular contact via swiping (e.g., browsing the contacts list manually by swiping through contacts) can be difficult. As an alternative to swiping in the contacts list, the user could also select the first letters of the surname. However, the first letters of a surname are generally displayed in a very small font. It is thus very easy to select incorrectly and then have to select again. In the example of swipe searching through the contacts list, in the event that three or more consecutive rapid swipes in the contacts list are detected, or in the event that repeated reverse swipes (e.g., back-and-forth, up-and-down swipe searching) are detected, then the determination is made that the user has a search need. In the event that it is determined that the user has a search need, a customized system control can be displayed. As an example, the system control can be customized to include a contacts list-related query tag (e.g., an information tag) and/or function buttons. In the event that the current app is a contacts app (e.g., an address book app), the information tags can include one or more of a frequent contacts tag, a most recent call contacts tag, a contact group tag, and the function buttons can include a speech button. Frequent contacts could include contacts who frequently (e.g., in relation to a preset threshold and a time period) call or are called. Most recent calls could include contacts who called or were called in the most recent period of time, such as one day. Various other periods of time can be used in determining most recent calls. Various other forms of communication can be used to identify recent contacts (e.g., most recent texts, emails, social network messaging, etc.). The contact group may include a pre-configured contact group such as friends, family, colleagues, etc. As an example, the contact group can be pre-configured by the user.

FIG. 7 is a diagram of an interface diagram according to various embodiments of the present application.

Referring to FIG. 7, interface 700 is provided. Interface 700 can be implemented by process 100 of FIG. 1, process 300 of FIG. 3, and/or process 600 of FIG. 6. Interface 700 can be implemented in connection with process 400 of FIG. 4. Interface 700 can be implemented by device 900 of FIG. 9, device 1000 of FIG. 10, terminal 1100 of FIG. 11, and/or a computing system such as computer system 1200 of FIG. 12.

Interface 700 can include a display of various contacts stored in connection with a contacts app (e.g., an address book). For example, the contacts can be stored locally at the terminal or remotely at a server (e.g., a server that facilitates communication exchange).

A target input can be used to activate a personal assistant system control. For example, system control display interface 710 corresponding to the system control can be displayed in the event that one or more inputs are detected that correspond to a call for the system control (e.g., that are deemed to correspond to an indication that the user needs the system control or wants to perform a query). System control display interface 710 can be customized based at least in part on the user, the current app (e.g., the contacts app), or the like. For example, system control display interface 710 displays the information tags “Fan Guangyi” 720, Guo Enke” 730, “Hong Guangjun” 740, and “Hua Jun” 750. As another example, the right lower corner of the system control display interface 710 displays a function button 760. Function button 760 can be configured as a speech button, the selection of which allows the user to directly input speech.

Thus, the user can select an information tag (e.g., information tag 720, 730, 740, or 750) within the system control or the speech button (e.g., function button 760) to trigger a corresponding query condition. The system control assists the user in executing the operation. For example, in the event that the user clicks the “Guo Enke” information tag 730, a query condition is generated for selecting “Guo Jinke,” and the query condition is forwarded to the contacts app for querying and displaying contact information corresponding to “Guo Jinke” contact information or for direct dialing of the “Guo Enke” telephone number. As another example, in the event that function button 760 corresponding to a speech button is selected and the user records “Call Little Zhang,” the system control can recognize the speech signals (e.g., process the speech signals), and forward the speech signals to the contacts app for querying and for dialing the telephone number corresponding to “Little Zhang.”

In some embodiments, in response to detecting continuous swiping or repeated reversal actions that occur on the contacts list page, the terminal (e.g., the system control, the operating system, or another background process) determines that the input corresponds to a call for the system control. For example, it can be deemed that the user is searching for a contact without success. As a result, a display interface for a personal assistant (e.g., the system control display interface corresponding to the system control) is actively displayed and one or more recommendations such as recommendation tags are provided. For example, the system control can recommend the contacts that the user most likely wishes to find. The user can click on the frequent contact or the voice dialogue, which will help the user find the contact that the user is looking for.

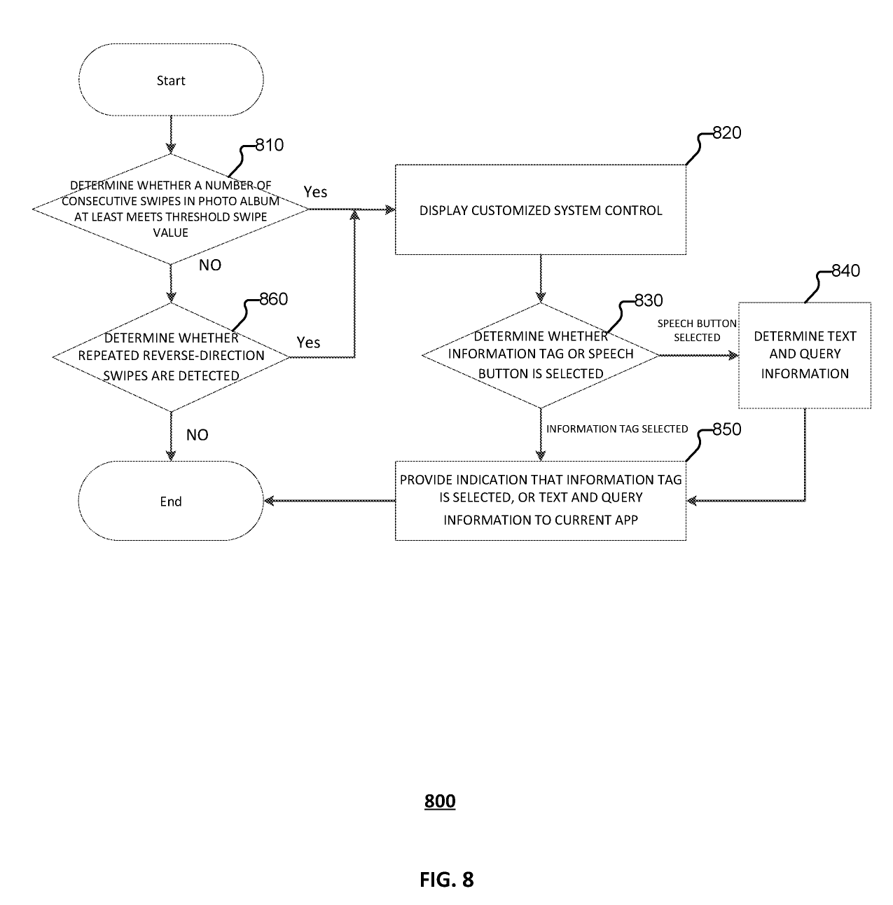

FIG. 8 is a flowchart of a method for data processing based on a swipe input according to various embodiments of the present application.

Referring to FIG. 8, process 800 for displaying information or interfaces in connection with a query is provided. Process 800 can be implemented to operate a system control and/or display a system control display interface. Process 800 can implement process 300 of FIG. 3 and/or process 400 of FIG. 4. Process 800 can be implemented by device 900 of FIG. 9, device 1000 of FIG. 10, and/or terminal 1100 of FIG. 11. Process 800 can be implemented by a computing system such as computer system 1200 of FIG. 12.

At 810, it can be determined whether a number of consecutive swipes input in connection with display of a photo album (e.g., by a photos app, a media app or the like) at least meets a threshold swipe value. The determination of whether the number of consecutive swipes at least meets the threshold swipe value can be performed by the system control, a system-level module, and/or the operating system of the terminal. The determining of whether the number of consecutive swipes at least meets the threshold swipe value can include determining whether an input to the terminal (e.g., the touchscreen) corresponds to a swipe (e.g., based at least in part on swipe information). The threshold swipe value can be configurable. For example, the threshold swipe value can be set according to manufacturer settings, user preferences, app settings (e.g., settings for the current app), etc.

In the event that the number of consecutive swipes input in connection with display of the photo album at least meets the threshold swipe value, then process 800 can proceed to 820. At 820, a customized system control can be displayed. Display of the customized system control can be based at least in part on the current app (e.g., the photos app or the media app), historical use data (e.g., of the current app, or of the terminal, generally), swipe information corresponding to the one or more consecutive swipes, etc.

In the event that the number of consecutive swipes input in connection with display of the photo album does not at least meet the threshold swipe value, then process 800 can proceed to 860. At 860, it can be determined whether repeated reverse-direction swipes are detected. A reverse-direction swipe can correspond to a back-and-forth swipe such as an up-and-down swipe, or a right-and-left swipe. For example, a reverse-direction swipe can include a sequence of two or more swipes having a swipe in a first direction and another swipe that is in a second direction that is a reverse direction in relation to the first direction. In some embodiments, it is determined whether a threshold value (or more) of reverse-direction swipes is detected. Detection of a threshold value of reverse-direction swipes can be deemed an indication that the user needs assistance (e.g., that the user wants to activate/display the system control or that the user wants to perform a query). In the event that it is determined that repeated reverse-direction swipes are not detected at 860, then process 800 can end. In the event that it is determined that repeated reverse-direction swipes are detected at 860, then process 800 can proceed to 820.

In the event that the customized system control is displayed, at 830 it can be determined whether an information tag or a speech button is selected. For example, it can be determined whether an input is made to the system control. The information tag and the speech button can be included in the customized system control.

In the event that it is determined that the information tag or the speech button is selected at 830, process 800 can proceed to 840 at which text and query information can be determined. For example, the text and/or query information can be obtained based at least in part on the selected information tag or speech button. In the event that the information tag or the speech button is selected, a speech recording can be input to a microphone of the terminal and the obtained speech recording can be processed (e.g., using speech-to-text processing) and text and/or query information can be obtained. Thereafter, process 800 can proceed to 850.

In the event that an information tag is selected at 830, process 800 can proceed to 850.

At 850, a current app can be provided with an indication that the applicable information tag is selected (e.g., as determined at 830), or with text and query information (e.g., as obtained and determined at 840 based on selection of the speech button at 830).

In view of the above, in the example of the search for a photograph in a photo album (e.g., a photos app, a media app, or the like), as shown in FIG. 8, a user can swipe up, down, left or right in the photo album searching for a photo. However the photo album may have a large number of photos. Because the photo album has a large number of photos, searching for a particular photo via swiping (e.g., browsing the photo album manually by swiping through photos) can be difficult. In the example of swipe searching through the photo album, in the event that three or more consecutive, rapid swipes in the photo album are detected, or in the event that repeated reverse swipes (e.g., back-and-forth, up-and-down swipe searching) are detected, then the determination is made that the user has a search need. In the event that it is determined that the user has a search need, a customized system control can be displayed. As an example, the system control can be customized to include a photo album-related query tag (e.g., an information tag) and a function button as the interface elements. In the event that the current app is a photo album app (e.g., a photos app, a media app, or the like), the information tags can include one or more of a screenshot tag, a most recent picture tag, a specific ranking tag, and a marked tag, and the function button can include a speech button. Screenshots can include instant pictures of all types of content displayed on a captured screen. Most recent pictures can include the pictures taken within the most recent period of time, such as within one month. Various other periods of time can be used in determining most recent pictures. Specific rankings can be ranked according to time, content, etc. Marking can include photographs pre-marked by the user, such as those marked as “Like.” Various other forms of media can be used other than photos, such as videos, or the like.

The user can select a query tag within the system control or the speech button to trigger a corresponding query condition. The system control assists the user in executing the operation. For example, in the event that the user clicks on a “Taken this month” information tag, the query condition for searching the query key word “this month” can then be generated and forwarded to the photo album via an API provided by the operating system and/or the photo album app. The photo album can find the pictures taken this month based at least in part on the query and display the pictures corresponding to the query results. As another example, in the event that the user records “screenshot” in connection with selecting the speech button, the terminal (e.g., the system control) can recognize the speech signals (e.g., process the speech signals to text), generate a query condition associated with searching for “screenshot,” and forward the query condition to the photo album (e.g., the photos app, media app, or the like). In the event that the photo album receives the query condition, the photo album finds corresponding screenshot pictures (e.g., all stored screenshot pictures) and displays the corresponding screenshot pictures.

In some embodiments, in response to detecting continuous swiping or repeated reversal actions occurring on the photo album list page, the terminal (e.g., the system control, the operating system, or another background process) determines that the input corresponds to a call for the system control. For example, it can be deemed that the user is searching for some photos without success. As a result, a display interface for a personal assistant (e.g., the system control display interface corresponding to the system control) is actively displayed and one or more recommendations such as recommendation tags are provided. For example, the system control can actively recommend the photos that the user is most likely to browse. The user can click on these frequent photo titles or the voice dialogue, which will help the user find the photo that the user is looking for.

If a lot of user data (e.g., many photographs, many contacts, or the like) is stored (e.g., either locally or on a remote storage) and a search is performed against the stored data, finding a specific piece of data can be difficult. Various embodiments deduce the user's intention (e.g., by determining that one or more inputs to the user are associated with, or otherwise mapped to, a call for the system control), actively understand the user's need (e.g., determines a context of the one or more inputs and determines operations or functions associated with the context and/or inputs), and promptly provide assistance to help the user quickly locate the needed data. For example, various embodiments actively provide a reminder by presenting the titles of the most recently taken photos or the titles of photos marked as “Like.” The user can click a title (e.g., of the presented titles) and directly browse the photos. If the recommended information tags fail to meet the user's need, the user can also directly use a voice description. For example, the user can record “Hangzhou photos taken in May,” and thus a search is executed. Photos that match the query can be provided.

Please note that all the method embodiments have been presented as a series of a combination of actions in order to simplify the description. However, persons skilled in the art should know that embodiments of the present application are not limited by the action sequences that are described, for some of the steps may make use of another sequence or be implemented simultaneously in accordance with embodiments of the present application. Secondly, persons skilled in the art should also know that the embodiments described in the description are all preferred embodiments. The actions that they involve are not required by embodiments of the present application.

FIG. 9 is a structural block diagram of a data processing device according to various embodiments of the present application.

Referring to FIG. 9, device 900 can be implemented in connection with accessing or otherwise obtaining information on a device. Device 900 can be implemented to display screen 200 of FIG. 2, screen 500 of FIG. 5, and/or screen 700 of FIG. 7. Device 900 can implement process 100 of FIG. 1, process 300 of FIG. 3, process 400 of FIG. 4, process 600 of FIG. 6, and/or process 800 of FIG. 8. Device 900 can be implemented in connection with device 1000 of FIG. 10 and/or terminal 1100 of FIG. 11. Device 900 can be implemented by a computing system such as computer system 1200 of FIG. 12.

Device 900 can include one or more of receiving module 910, a control displaying module 920, and a query response module 930.

In some embodiments, receiving module 910 is configured to receive an input. For example, receiving module 910 can receive an input to a terminal (e.g., an input to a touchscreen of the terminal). In some embodiments, the receiving module 910 receives an input to a current app. Receiving module 910 can receive to an app interface non-control zone (e.g., of the current app). In some embodiments, the app interface non-control zone corresponds to an area of a graphical user interface displayed in connection with the app. The non-control zone can be an area in which there are no other elements that can be selected or activated in response to an input to the app or terminal.

In some embodiments, control displaying module 920 is configured to display a system control. Control displaying module 920 can display the system control (e.g., a system control display interface) in response to determining that the input satisfies a preset query trigger condition. The system control can display interface elements related to the current app. Control displaying module 920 can obtain interface elements related to the current app in connection with display of the system control. As an example, control displaying module 920 can determine whether the received input corresponds to an input that is associated with the performing of a query. The interface elements can correspond to suggested query criteria (e.g., the query words) based on the context of the terminal such as based on the current app. For example, the suggested query criteria can be determined according to information associated with the current app such as a type of app, information being displayed by the current app, or the like. Suggested query criteria can be stored in a table that stores associations or mappings of query criteria according to context (e.g., the current app, information being displayed, etc.).

In some embodiments, query response module 930 is configured to display a query response (e.g., via a query response interface). For example, query response module 930 can display the query response interface obtained according to the query condition corresponding to a triggered interface element (e.g., a selected interface element) in response to the interface element being triggered.

In some embodiments, a system control is displayed in the event that a specific input (e.g., a predefined input) is received, and a query condition is generated based at least in part on the selection of the interface element. A query can be performed based at least in part on the query condition and a response is provided to the query condition. Various embodiments can predict a user's query needs (e.g., based at least in part on one or more of a received input or selection, a context of the input or the current app, a type of the current app, etc.), actively display a system control, and thus, with the system control, assist the user in executing the query. Accordingly, operating efficiency in relation to operating a terminal or a current app can be improved.

FIG. 10 is a structural block diagram of a data processing device according to various embodiments of the present application.

Referring to FIG. 10, device 1000 can be implemented in connection with accessing or otherwise obtaining information on a device. Device 1000 can be implemented to display screen 200 of FIG. 2, screen 500 of FIG. 5, and/or screen 700 of FIG. 7. Device 1000 can implement process 100 of FIG. 1, process 300 of FIG. 3, process 400 of FIG. 4, process 600 of FIG. 6, and/or process 800 of FIG. 8. Device 1000 can be implemented in connection with device 900 of FIG. 9 and/or terminal 1100 of FIG. 11. Device 1000 can be implemented by a computing system such as computer system 1200 of FIG. 12.

Device 1000 can include one or more of receiving module 1010, control displaying module 1020, query response module 1030, and input determining module 1040.

In some embodiments, input determining module 1040 is configured to obtain swipe information from a touchscreen. The swipe information can correspond to an input to the touchscreen. The touchscreen can include one or more sensors that monitor for inputs and collect information associated with an input (e.g., a swipe). In some embodiments, the swipe information can include swipe distance, swipe direction, swipe duration, swipe location, etc. The swipe information can be obtained by the system control, an operating system running on the terminal, or the like. Input determining module 1040 can be configured to determine whether to perform a query based at least in part on the received input (e.g., the swipe information). For example, input determining module 1040 can be configured to determine whether the input satisfies the preset query trigger condition. For example, it can be determined whether the received input corresponds to an input that is associated with the performing of a query. In some embodiments, a table or other database can be stored in which associations between inputs and corresponding functions or actions are mapped and stored. The determining of whether to perform the query based at least in part on the input can include determining whether the received input has a corresponding function or action mapped thereto (e.g., the corresponding function can be looked up in the table storing the associations or mappings of inputs to functions). If a function is associated with the received input, it can be determined whether the function is a function for performing a query. The query can correspond to a query within the app or a global query on a terminal according to which information external to the app is searched or queried (e.g., subject to the query).

In some embodiments, receiving module 1010 is configured to receive an input. For example, receiving module 1010 can receive an input to a terminal (e.g., an input to a touchscreen of the terminal). In some embodiments, the receiving module 1010 receives an input to a current app. Receiving module 1010 can receive to an app interface non-control zone (e.g., of the current app). In some embodiments, the non-control zone corresponds to an area of a graphical user interface displayed in connection with the app. The non-control zone can be an area in which there are no other elements that can be selected or activated in response to an input to the app or terminal. Receiving module 1010 can correspond to, or be implemented as, receiving module 910 of device 900 of FIG. 9.

In some embodiments, control displaying module 1020 is configured to display a system control. Control displaying module 1020 can display the system control (e.g., a system control display interface) in response to determining that the input satisfies a preset query trigger condition. The system control can display interface elements related to the current app. Control displaying module 1020 can obtain interface elements related to the current app in connection with display of the system control. As an example, control displaying module 1020 can determine whether the received input corresponds to an input that is associated with the performing of a query. The interface elements can correspond to suggested query criteria (e.g., the query words) based on the context of the terminal such as based on the current app. For example, the suggested query criteria can be determined according to information associated with the current app such as a type of app, information being displayed by the current app, or the like. Suggested query criteria can be stored in a table that stores associations or mappings of query criteria according to context (e.g., the current app, information being displayed, etc.).

In some embodiments, query response module 1030 is configured to display a query response (e.g., via a query response interface). For example, query response module 1030 can display the query response interface obtained according to the query condition corresponding to a triggered interface element (e.g., a selected interface element) in response to the interface element being triggered.

In some embodiments, control displaying module 1020 is further configured to determine interface elements related to the current app. Control displaying module 1020 can comprise one or more of element determining submodule 1022, interface customizing submodule 1024, and floating window display submodule 1026.

In some embodiments, element determining submodule 1022 is configured to obtain interface information or the app package name of the current app, and to determine interface elements based at least in part on the app package name or interface information. The interface elements can include an information tag and/or a function button.

In some embodiments, interface customizing submodule 1024 is configured to customize the display interface for the system control according to the interface elements.

In some embodiments, floating window display submodule 1026 is configured to activate a floating window with the app interface of the current app as the background, and display the system control display interface in the floating window. The floating window can be overlaid with the interface of the current app.

In some embodiments, query response module 1030 includes one or more of condition-determining submodule 1032 and response submodule 1034.

In some embodiments, condition-determining submodule 1032 is configured to determine the query condition for the current app based at least in part on the triggering of the interface element. For example, the query condition for the current app can be determined on a selection of an interface element.

In some embodiments, response submodule 1034 is configured to perform a query and to display query results. For example, response submodule 1034 can perform a query based at least in part on the querying condition. Response submodule 1034 can display a query response interface. The query response interface can include results of the query.

In some embodiments, information tags comprise a query tag. Condition-determining submodule 1032 can be configured to receive one or more query key words based at least in part on a triggering (e.g., a selection) of the query tag. Condition-determining submodule 1032 can be configured to generate a query condition for the current app based at least in part on the one or more query key words.

In some embodiments, the function buttons comprise a speech button. The speech button can activate a recording and/or processing of speech input (e.g., to a microphone of the terminal). Condition-determining submodule 1032 is configured to receive speech signals in response to selection of the speech button, to recognize the speech signals, to determine the one or more query key words, based at least in part on the speech signals, and to generate a query condition for the current app based at least in part on the one or more query words. To recognize the speech signals can include performing a speech-to-text processing to obtain text corresponding to the speech signals.

Response submodule 1034 can be configured to communicate a query condition to the current app. The current app can obtain one or more query key words corresponding to the query condition, and perform a query based on the one or more query key words.

In some embodiments, the information tags comprise a function entry recommendation tag. Condition-determining submodule 1032 can be configured to receive function entry information, and to generate a query condition for the current app. Condition-determining submodule 1032 can receive the function entry information in response to selection of the information tag. Condition-determining submodule 1032 can generate the query condition for the current app based at least in part on the function entry information.

Response submodule 1034 can be configured to communicate or otherwise provide the query condition to the current app. The current app can obtain the function entry corresponding to the query condition. The current app can enter the function entry, and display the display interface corresponding to the function entry.

In some embodiments, input determining module 1040 is configured to determine the target swipe operation based at least in part on the swipe direction. In the event that the swipe duration of the target swipe operation at least meets a preset time, the target swipe operation can be recorded as a valid input. Input determining module 1040 can determine whether the number of corresponding instances of the valid input of the target swipe operation at least meets a valid threshold value. In the event that the number of valid input corresponding instances at least meets the valid threshold value, the valid input can be determined to satisfy the preset query trigger condition. In the event that the number of valid input corresponding instances fails to at least meet the valid threshold value, the valid input can be determined to not satisfy the preset query trigger condition.

In some embodiments, the current app is a contacts app. In the event that the current app is a contacts app, the information tags can comprise one or more of a frequent contacts tag, a most recent call contacts tag, a contact group tag, and the function button can comprise a speech button.

In some embodiments, the current app is a photo album app. In the event that the current app is a photo album app, the information tags can comprise one or more of a screenshot tag, a most recent picture tag, a specific ranking tag, and a marked tag, and the function button can comprise a speech button.

In some embodiments, the current app is a system desktop. In the event that the current app is a system desktop, the information tags can comprise one or more of an entry tag for recommended apps, an entry tag for most often used apps, and the function button can comprise a speech button.

In some embodiments, the current app is system settings. In the event that the current app is a system settings, the information tags can comprise one or more of an entry tag for recommended settings, an entry app tag for most often modified settings, and the function button can comprise a speech button.

In the event that a lot of user data is stored (e.g., many photographs or many contacts), finding a specific piece of data can be difficult. Various embodiments deduce the user's intention, actively understand the user's need, and promptly provide assistance to help the user quickly locate the needed data. For example, various embodiments actively provide a reminder by presenting the titles of the most recently taken photos or the titles of photos marked as “Like.” The user can click a title and directly browse the photos. If the recommended information tags fail to meet the user's need, the user may also directly use a voice description. For example, the user records “Hangzhou photos taken in May,” and thus a search is executed. Photos that meet the need are provided.

FIG. 11 is a structural block diagram of a mobile terminal according to various embodiments of the present application.

Referring to FIG. 11, terminal 1100 can be implemented in connection with accessing or otherwise obtaining information on a device. Terminal 1100 can be implemented to display screen 200 of FIG. 2, screen 500 of FIG. 5, and/or screen 700 of FIG. 7. Terminal 1100 can implement process 100 of FIG. 1, process 300 of FIG. 3, process 400 of FIG. 4, process 600 of FIG. 6, and/or process 800 of FIG. 8. Terminal 1100 can be implemented in connection with device 900 of FIG. 9, and/or device 1000 of FIG. 10. Terminal 1100 can be implemented by a computing system such as computer system 1200 of FIG. 12.

Terminal 1100 can comprise memory 1110, display module 1120, one or more processors 1130, and input module 1140.

The input module 1140 may be configured to receive numeric or character information input by the user and control signals. Input module 1140 can comprise a touchscreen 1142, which can collect touch operations performed by the user thereon or nearby. For example, the user can use a finger, a touch pen, or any suitable object or accessory to perform operations on the touchscreen 1142. Moreover, input module 1140 can drive the appropriate connected devices according to a preset program. Of course, the input module 1140 may comprise other input devices in addition to the touchscreen 1142. Examples include a physical keyboard, function keys (e.g., a volume control key or a switch key), and a mouse.

The display module 1120 can comprise a display panel. Optionally, the display panel may be configured as a Liquid Crystal Display (LCD) or an Organic Light-Emitting Diode

(OLED), etc. The touchscreen (e.g., touchscreen 1142) may be covered by a display panel to form a touch-display screen. In the event that the touch-display screen detects a touch operation thereon or nearby, the touch-display screen transmits the touch operation to the one or more processors 1130 to execute the appropriate processing.

According to various embodiments, by invoking the software programs and/or modules and/or data stored in the memory 1110, the one or more processors 1130 are used in a current app to receive input in an app interface non-control zone; upon determining that the input satisfies a preset query trigger condition, the one or more processors 1130 display (e.g., via display module 1120) a system control. The system control can comprise obtaining interface elements related to the current app. The one or more processors 1130 can display the query response interface obtained according to the query condition corresponding to the triggered interface element. The one or more processors 1130 can display the query response interface in response to the selecting of the interface element.

The determining the interface elements related to the current app can include acquiring the app package name of the current app, and determining, based at least in part on the app package name, an interface element. For example, the interface elements can include one or more of information tags and function buttons.

The displaying a system control can include customizing a system control display interface based at least in part on the interface elements, activating a floating window with the app interface of the current app as the background, and displaying the system control in the floating window of the display interface.

The displaying of the query response interface obtained according to the query condition corresponding to the triggered interface element can include determining the query condition for the current app, querying the query condition, and displaying the corresponding query response page. The determining of the query condition, performing the query, and displaying the corresponding query response page can be performed based at least in part on the selection of the interface element.

The information tags can comprise a query tag. The determining the query condition for the current app based at least in part on the selection of the interface element comprises receiving query key words based at least in part on the selection of the query tag, and using the query key words to generate a query condition for the current app.

The function buttons can comprise a speech button. The determining the query condition for the current app based at least in part on the selection of the interface element can include receiving speech signals in response to the selection of the speech button, recognizing the speech signals, determining query key words (e.g., based at least in part on the speech signals), and using the query key words to generate a query condition for the current app.

The query condition being queried can comprise sending the query condition to the current app. The current app can obtain the query key words corresponding to the query condition, and perform a query based on the query key words.

The generating the query condition for the current app based at least in part on the selecting of the interface element can comprise receiving function entry information as a result of selecting the information tag, and generating a query condition for the current app based at least in part on the function entry information.

The querying of the query condition and displaying the corresponding query response interface can comprise sending the query condition to the current app. The current app can obtain the function entry corresponding to the query condition, enter the function entry, and display the display interface corresponding to the function entry.

It can be determined that the input satisfies a preset query trigger condition. Swipe information can be obtained from a touchscreen, and it can be determined whether the input satisfies the preset query trigger condition based at least in part on the swipe information.

The swipe information can comprise a swipe direction and a swipe time. It can be determined whether the input satisfies a preset query trigger condition based at least in part on the swipe information. For example, determining whether the input satisfies a preset query trigger condition can include determining the target swipe operation based at least in part on the swipe direction. In the event that the swipe duration of the target swipe operation at least meets a preset time, the input can be recorded as a valid input for the target swipe operation. It can be determined whether the number of corresponding instances of the valid input of the target swipe operation at least meets a valid threshold value. In the event that the number of valid input corresponding instances at least meets the valid threshold value, the valid input can be deemed to satisfy the preset query trigger condition. In the event that the number of valid input corresponding instances fails to at least meet the valid threshold value, the valid input can be deemed to not satisfy the preset query trigger condition.

In the event that the current app is a contacts app, the information tags can comprise one or more of a frequent contacts tag, a most recent call contacts tag, and a contact group tag, and the function button can include a speech button.

In the event that the current app is a photo album app, the information tags can include one or more of a screenshot tag, a most recent picture tag, a specific ranking tag, and a marked tag, and the function button can include a speech button.

In the event that the current app is system settings, the information tags can include one or more of an entry tag for recommended settings, and an entry app tag for most often modified settings, and the function buttons can include a speech button.

FIG. 12 is a functional diagram of a computer system for processing data according to various embodiments of the present disclosure.

Referring to FIG. 12, a computer system 1200 for processing data is shown. As will be apparent, other computer system architectures and configurations can be used to detect a specified identifier. Computer system 1200, which includes various subsystems as described below, includes at least one microprocessor subsystem (also referred to as a processor or a central processing unit (CPU)) 1202. For example, processor 1202 can be implemented by a single-chip processor or by multiple processors. In some embodiments, processor 1202 is a general purpose digital processor that controls the operation of the computer system 1200. Using instructions retrieved from memory 1210, the processor 1202 controls the reception and manipulation of input data, and the output and display of data on output devices (e.g., display 1218).

Processor 1202 is coupled bi-directionally with memory 1210, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 1202. Also as is well known in the art, primary storage typically includes basic operating instructions, program code, data, and objects used by the processor 1202 to perform its functions (e.g., programmed instructions). For example, memory 1210 can include any suitable computer-readable storage media, described below, depending on whether, for example, data access needs to be bi-directional or uni-directional. For example, processor 1202 can also directly and very rapidly retrieve and store frequently needed data in a cache memory (not shown). The memory can be a non-transitory computer-readable storage medium.

A removable mass storage device 1212 provides additional data storage capacity for the computer system 1200, and is coupled either bi-directionally (read/write) or uni-directionally (read only) to processor 1202. For example, storage 1212 can also include computer-readable media such as magnetic tape, flash memory, PC-CARDS, portable mass storage devices, holographic storage devices, and other storage devices. A fixed mass storage 1220 can also, for example, provide additional data storage capacity. The most common example of mass storage 1220 is a hard disk drive. Mass storage device 1212 and fixed mass storage 1220 generally store additional programming instructions, data, and the like that typically are not in active use by the processor 1202. It will be appreciated that the information retained within mass storage device 1212 and fixed mass storage 1220 can be incorporated, if needed, in standard fashion as part of memory 1210 (e.g., RAM) as virtual memory.

In addition to providing processor 1202 access to storage subsystems, bus 1214 can also be used to provide access to other subsystems and devices. As shown, these can include a display monitor 1218, a network interface 1216, a keyboard 1204, and a pointing device 1206, as well as an auxiliary input/output device interface, a sound card, speakers, and other subsystems as needed. For example, the pointing device 1206 can be a mouse, stylus, track ball, or tablet, and is useful for interacting with a graphical user interface.

The network interface 1216 allows processor 1202 to be coupled to another computer, computer network, or telecommunications network using a network connection as shown. For example, through the network interface 1216, the processor 1202 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 1202 can be used to connect the computer system 1200 to an external network and transfer data according to standard protocols. For example, various process embodiments disclosed herein can be executed on processor 1202, or can be performed across a network such as the Internet, intranet networks, or local area networks, in conjunction with a remote processor that shares a portion of the processing. Additional mass storage devices (not shown) can also be connected to processor 1202 through network interface 1216.

An auxiliary I/O device interface (not shown) can be used in conjunction with computer system 1200. The auxiliary I/O device interface can include general and customized interfaces that allow the processor 1202 to send and, more typically, receive data from other devices such as microphones, touch-sensitive displays, transducer card readers, tape readers, voice or handwriting recognizers, biometrics readers, cameras, portable mass storage devices, and other computers.

The computer system shown in FIG. 12 is but an example of a computer system suitable for use with the various embodiments disclosed herein. Other computer systems suitable for such use can include additional or fewer subsystems. In addition, bus 1214 is illustrative of any interconnection scheme serving to link the subsystems. Other computer architectures having different configurations of subsystems can also be utilized.

The modules described as separate components may or may not be physically separate, and components displayed as modules may or may not be physical modules. They can be located in one place, or they can be distributed across multiple network modules. The embodiment schemes of the present embodiments can be realized by selecting part or all of the modules in accordance with actual need.

Furthermore, the functional modules in the various embodiments of the present invention can be integrated into one processor, or each module can have an independent physical existence, or two or more modules can be integrated into a single module. The aforesaid integrated modules can take the form of hardware, or they can take the form of hardware combined with software function modules.

Each of the embodiments contained in this description is described in a progressive manner, the explanation of each embodiment focuses on areas of difference from the other embodiments, and the descriptions thereof may be mutually referenced for portions of each embodiment that are identical or similar.

A person skilled in the art should understand that an embodiment of the present application may provide methods, devices, or computer program products. Therefore, the embodiments of the present application may take the form of embodiments that are entirely hardware, embodiments that are entirely software, and embodiments that combine hardware and software aspects. Moreover, embodiments of the present application may employ one or more forms of computer products that implement computer-operable storage media (including but not limited to magnetic disk storage devices, CD-ROMs, and optical storage devices) containing computer-operable computer code.

In one typical configuration, the computer equipment comprises one or more processors (CPUs), input/output interfaces, network interfaces, and memory. Memory may include such forms as volatile storage devices in computer-readable media, random access memory (RAM), and/or non-volatile memory, such as read-only memory (ROM) or flash memory (flash RAM). Memory is an example of a computer-readable medium. Computer-readable media, including permanent and non-permanent and removable and non-removable media, may achieve information storage by any method or technology. Information can be computer-readable commands, data structures, program modules, or other data. Examples of computer storage media include but are not limited to phase-change memory (PRAM), static random access memory (SRAM), dynamic random access memory (DRAM), other types of random access memory (RAM), read-only memory (ROM), electrically erasable programmable read-only memory (EEPROM), flash memory or other memory technology, compact disk read-only memory (CD-ROM), digital multifunction disc (DVD) or other optical storage, magnetic cassettes, magnetic tape or magnetic disc storage, or other magnetic storage equipment or any other non-transmission media that can be used to store information that is accessible to computers. As defined in this document, computer-readable media does not include transitory computer-readable media, (transitory media), such as modulated data signals and carrier waves.

The embodiments of the present application are described with reference to flowcharts and/or block diagrams based on methods, terminal equipment (systems), and computer program products of the embodiments of the present application. Please note that each flowchart and/or block diagram within the flowcharts and/or block diagrams and combinations of flowcharts and/or block diagrams within the flowcharts and/or block diagrams can be realized by computer commands. These computer program commands can be provided to the processors of general-purpose computers, specialized computers, embedded processor devices, or other programmable data processing terminals to produce a machine. The commands executed by the processors of the computers or other programmable data processing terminal equipment consequently give rise to devices for implementing the functions specified in one or more processes in the flowcharts and/or one or more blocks in the block diagrams.

These computer program commands can also be stored in computer-readable memory that can guide the computers or other programmable data processing terminal equipment to operate in a specific manner. As a result, the commands stored in the computer-readable memory give rise to products including command devices. These command devices implement the functions specified in one or more processes in the flowcharts and/or one or more blocks in the block diagrams.

These computer program commands can also be loaded onto computers or other programmable data processing terminal equipment and made to execute a series of steps on the computers or other programmable data processing terminal equipment so as to give rise to computer-implemented processing. The commands executed on the computers or other programmable data processing terminal equipment thereby provide the steps of the functions specified in one or more processes in the flowcharts and/or one or more blocks in the block diagrams.

Although preferred embodiments of the present application have already been described, a person skilled in the art can make other modifications or revisions to these embodiments once the basic creative concept is grasped. Therefore, the attached claims are to be interpreted as including the preferred embodiments as well as all modifications and revisions falling within the scope of the embodiments of the present application.

Lastly, it must also be explained that, in this document, relational terms such as “first” or “second” are used only to differentiate between one entity or operation and another entity or operation, without necessitating or implying that there is any such actual relationship or sequence between these entities or operations. Moreover, the term “comprise” or “contain” or any of their variants are to be taken in their non-exclusive sense. Thus, processes, methods, things, or terminal devices that comprise a series of elements not only comprise those elements, but also comprise other elements that have not been explicitly listed or elements that are intrinsic to such processes, methods, things, or terminal devices. In the absence of further limitations, elements that are limited by the phrase “comprises a(n) . . .” does not exclude the existence of additional identical elements in processes, methods, things, or terminal devices that comprise the elements.

The above is a detailed description of a method for processing data, a device for processing data, and a smart terminal, which are provided for the present application. This document applies specific examples in explicating the principles and implementation of the present application. The explanations of the above embodiments are only in order to aid understanding of the present application methods and their core concepts. Furthermore, persons with typical skill in the art can always modify specific implementations and scopes of the application in accordance with the concept of the present application. To summarize the above, the content of this description should not be understood as limiting the present application.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
receiving an input to an application interface non-control zone of a current application;
determining whether the input satisfies a preset query trigger condition;
in the event that the input is determined to satisfy the preset query trigger condition, displaying a system control, wherein the system control obtains one or more interface elements related to the current application and displays the one or more interface elements;
receiving a triggering of at least one of the one or more interface elements; and
in response to the triggering of the at least one of the one or more interface elements, displaying a query response interface, wherein the query response interface is obtained according to a query condition associated with the triggered at least one of the one or more interface elements.

2. The method of claim 1, further comprising determining the one or more interface elements related to the current application.

3. The method of claim 2, wherein determining the one or more interface elements related to the current application comprises:
obtaining an application package name of the current application; and
determining, based at least in part on the application package name, at least one of an information tag and function button.

4. The method of claim 1, wherein the displaying of the system control comprises:
customizing a system control display interface for the system control, the system control display interface being customized based at least in part on the one or more interface elements; and
activating and displaying a floating window, wherein the floating window is displayed with an application interface of the current application as a background to the floating window, and the floating window comprises the system control display interface.

5. The method of claim 1, wherein the displaying of the query response interface comprises:
determining the query condition for the current application;
performing a query based at least in part on the query condition; and
displaying the query response interface based at least in part on the query.

6. The method of claim 1, wherein the displaying of the query response interface comprises:
customizing a system control display interface for the system control, the system control display interface being customized based at least in part on the one or more interface elements; and
determining the query condition for the current application based at least in part on the triggering of the at least one of the one or more interface elements, wherein the one or more interface elements comprise a query tag, and the determining of the query condition comprises:
in the event that the query tag corresponds to the triggering of the at least one of the one or more interface elements, receiving one or more query key words based at least in part on the query tag; and
generating the query condition for the current application based at least in part on the one or more query key words.

7. The method of claim 1, wherein the displaying of the query response interface comprises:
is customizing a system control display interface for the system control, the system control display interface being customized based at least in part on the one or more interface elements;
determining the query condition for the current application based at least in part on the triggering of the at least one of the one or more interface elements, wherein the one or more interface elements comprise a speech button, and the determining of the query condition comprises:
in the event that the speech button corresponds to the triggering of the at least one of the one or more interface elements, receiving one or more speech signals;
recognizing the one or more speech signals;
determining one or more query key words based at least in part on the one or more speech signals; and
generating the query condition for the current application based at least in part on the one or more query key words.

8. The method of claim 1, wherein the displaying of the query response interface comprises:
determining the query condition for the current application;
performing a query based at least in part on the query condition, including communicating the query condition to the current application, obtaining one or more query key words corresponding to the query condition, and conducting the query based at least in part on the one or more query key words; and
displaying the query response interface based at least in part on the query.

9. The method of claim 1, further comprising:
in response to receiving the triggering of the at least one of the one or more interface elements, determining the query condition for the current application based at least in part on the at least one of the one or more interface elements corresponding to the triggering, including:
receiving function entry information based at least in part on the at least one of the one or more interface elements; and
generating the query condition for the current application based at least in part on the function entry information.

10. The method of claim 1, wherein the displaying of the query response interface comprises:
determining the query condition for the current application; and
is performing a query based at least in part on the query condition, including:
communicating the query condition to the current application;
obtaining one or more query key words corresponding to the query condition;
conducting the query based at least in part on the one or more query key words;
inputting a function entry; and
displaying the query response interface based at least in part on the function entry.

11. The method of claim 1, wherein the determining of whether the input satisfies the preset query trigger condition comprises:
obtaining swipe information corresponding to the input from a touchscreen; and
determining whether the input satisfies the preset query trigger condition based at least in part on the swipe information.

12. The method of claim 1, wherein the determining of whether the input satisfies the preset query trigger condition comprises:
obtaining swipe information corresponding to the input from a touchscreen wherein the swipe information comprises a swipe direction and a swipe duration;
determining a target swipe operation based at least in part on the swipe direction;
determining whether the swipe duration of the target swipe operation at least meets a preset time;
in the event that the swipe duration of the target swipe operation at least meets the preset time, recording the target swipe operation as a valid input;
determining whether a number of corresponding instances of the valid input of the target swipe operation at least meets a valid threshold value;
in the event that the number of corresponding instances of the valid input at least meets the valid threshold value, determining that the valid input satisfies the preset query trigger condition; and
in the event that the number of corresponding instances of the valid input does not at least meet the valid threshold value, determining that the valid input does not satisfy the preset query trigger condition.

13. The method of claim 1, wherein the one or more interface elements comprise one or more information tags and one or more function buttons, and in the event that the current application is a contacts application, the one or more information tags comprise one or more of a frequent contacts tag, a most recent call contacts tag, a contact group tag, and the one or more function buttons comprise a speech button.

14. The method of claim 1, wherein the one or more interface elements comprise one or more information tags and one or more function buttons, and in the event that the current application is a photo album application, the one or more information tags comprise one or more of: a screenshot tag, a most recent picture tag, a specific ranking tag, and/or a marked tag, and wherein the one or more function buttons comprise a speech button.

15. The method of claim 1, wherein the one or more interface elements comprise one or more information tags and one or more function buttons, and in the event that the current application is a system settings application, the one or more information tags comprise an entry tag for recommended settings, an entry tag for most often modified settings, or both, and wherein the one or more function buttons comprise a speech button.

16. The method of claim 1, wherein the displaying the query response interface includes displaying one or more results to a query associated with the triggered at least one of the one or more interface elements.

17. A device, comprising:
one or more processors configured to:
receive an input to an application interface non-control zone of a current application;
determine whether the input satisfies a preset query trigger condition;
in the event that the input is determined to satisfy the preset query trigger condition, display a system control, wherein the system control obtains one or more interface elements related to the current application and displays the one or more interface elements;
receive a triggering of at least one of the one or more interface elements; and
in response to the triggering of the at least one of the one or more interface elements, display a query response interface, wherein the query response interface is obtained according to a query condition associated with the triggered at least one of the one or more interface elements; and
is a memory coupled to the one or more processors and configured to provide the one or more processors with instructions.

18. A computer program product, the computer program product being embodied in a non-transitory computer readable storage medium and comprising computer instructions for:
receiving an input to an application interface non-control zone of a current application;
determining whether the input satisfies a preset query trigger condition;
in the event that the input is determined to satisfy the preset query trigger condition, displaying a system control, wherein the system control obtains one or more interface elements related to the current application and displays the one or more interface elements;
receiving a triggering of at least one of the one or more interface elements; and
in response to the triggering of the at least one of the one or more interface elements, displaying a query response interface, wherein the query response interface is obtained according to a query condition associated with the triggered at least one of the one or more interface elements.
